(19) United States
(12) Patent Application Publication
(10) Pub. No.: US 2026/0037264 A1
(43) Pub. Date: Feb. 5, 2026

(54) COMPUTER ARCHITECTURE TO VALIDATE IMAGE FRAME AND IMAGE LINE DATA IN A SINGLE PASS

(71) Applicant: NVIDIA Corporation, Santa Clara, CA (US)

(72) Inventors: Lachlan Francis DOWLING, San Jose, CA (US); Dawid Stanislaw PAJAK, San Carlos, CA (US); Ching-Yu HUNG, Pleasanton, CA (US)

(73) Assignee: NVIDIA Corporation, Santa Clara, CA (US)

(21) Appl. No.: 18/789,915

(22) Filed: Jul. 31, 2024

(51) Int. Cl. G06F 9/38; G06F 9/30

(52) U.S. Cl. CPC G06F 9/38; G06F 9/30018; G06F 9/30032; G06F 9/30043

(57) ABSTRACT

Aspects of this technical solution can increase processing speed in low-latency application areas, while maintaining integrity of error correction detection at those higher speeds. For example, in image-processing environments associated with autonomous navigation (e.g., driving), a large volume of image data is to be rapidly and accurately processed to maintain reliable and up-to-date models of a physical environment. Thus, embodiments in accordance with this disclosure can provide high-speed and accurate error correction of input frame data beyond the capability of CPU processing or general GPU processing to achieve.

### TECHNICAL FIELD

The present implementations relate generally to microprocessor devices, including but not limited to a computer architecture to validate image frame and image line data in a single pass.

### INTRODUCTION

Computational processors are expected to handle increasingly complex datasets at increasing speed. However, conventional processing systems can have significant differences in processing speed or data transfer speed, resulting in mismatches between processing components that can reduce overall system performance and reduce or eliminate the ability to conduct various types of computational processes outright (e.g., image processing or graphics processing).

### SUMMARY

Aspects of this technical solution can increase speed of processing in low-latency application areas, while maintaining integrity of error correction detection at those higher speeds. For example, in image-processing environments associated with autonomous or semi-autonomous navigation (e.g., driving, robotics, etc.), a large volume of image and/or other sensor modality data is to be rapidly and accurately processed to maintain reliable and up-to-date models of a physical environment. For example, embodiments in accordance with this disclosure can provide high-speed and accurate error correction of input frame data or packet data in a single pass, beyond the capabilities that CPU processing or general GPU processing can effectively achieve, but are not limited thereto. For example, error correction code can correspond to a cyclic redundancy check code (“CRC”) but is not limited thereto. Thus, a technical solution for a computer architecture to validate image frame and image line data in a single pass is provided.

At least one aspect is directed to a system. The system can include one or more processors. The system can obtain a plurality of encodings in parallel via respective lanes of a processor, each of the plurality of encodings corresponding to respective rows of a frame of data. The system can append, in parallel via the respective lanes of the processor, a first set of bits to each of a set of rows of the respective rows. The system can load, in parallel via the respective lanes of the processor, respective encodings of the plurality of encodings into corresponding rows of the set of rows. The system can append, in parallel via the respective lanes of the processor, a plurality of sets of bits to the set of rows. The system can shift one or more of the set of rows to align each of the encodings with at least one of the first set of bits or one or more of the plurality of sets of bits. The system can load, in parallel via the respective lanes of the processor, each of the set of rows can include the encodings into a common row to form a frame encoding corresponding to the frame of the data.

At least one aspect is directed to a system. The system can include one or more processors. The system can determine, in parallel via a processor, a first set of bits for each of a set of respective rows of a frame of data. The system can load, in parallel via the processor, respective encodings of the plurality of encodings into corresponding rows of the set of rows. The system can determine, in parallel via the processor, a plurality of sets of bits for the set of rows. The system can combine each of the encodings with at least one of the first set of bits or one or more of the plurality of sets of bits. The system can load, in parallel via the processor, each of the set of rows can include the encodings into a common row to form a frame encoding corresponding to the frame of the data.

At least one aspect is directed to a system-on-chip (SoC). The system can include at least one graphics processing unit (GPU) providing multi-core parallel processing via a plurality of respective lanes, the GPU. The system can determine, in parallel via a processor, a first set of bits for each of a set of respective rows of a frame of data. The system can load, in parallel via the processor, respective encodings of the plurality of encodings into corresponding rows of the set of rows. The system can determine, in parallel via the processor, a plurality of sets of bits for the set of rows. The system can combine each of the encodings with at least one of the first set of bits or one or more of the plurality of sets of bits. The system can load, in parallel via the processor, each of the set of rows can include the encodings into a common row to form a frame encoding corresponding to the frame of the data.

At least one aspect is directed to a method. The method can include obtaining a plurality of encodings in parallel via respective lanes of a processor, each of the plurality of encodings corresponding to respective rows of a frame of data. The method can include appending, in parallel via the respective lanes of the processor, a first set of bits to each of a set of rows of the respective rows. The method can include loading, in parallel via the respective lanes of the processor, respective encodings of the plurality of encodings into corresponding rows of the set of rows. The method can include appending, in parallel via the respective lanes of the processor, a plurality of sets of bits to the set of rows. The method can include shifting one or more of the set of rows to align each of the encodings with at least one of the first set of bits or one or more of the plurality of sets of bits. The method can include loading, in parallel via the respective lanes of the processor, each of the set of rows can include the encodings into a common row to form a frame encoding corresponding to the frame of the data.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example computing environment in which one or more devices operate to process data using a SoC, in accordance with some embodiments of the present disclosure;

FIG. 2 depicts an example frame data structure, in accordance with some embodiments of the present disclosure;

FIG. 3 depicts an example architecture of line CRC input data structures, in accordance with some embodiments of the present disclosure;

FIG. 4 depicts an example architecture of frame CRC input data structures, in accordance with some embodiments of the present disclosure;

FIG. 5A depicts an example first state of CRC lines, in accordance with some embodiments of the present disclosure;

FIG. 5B depicts an example second state of the CRC lines, in accordance with some embodiments of the present disclosure;

FIG. 5C depicts an example third state of the CRC lines, in accordance with some embodiments of the present disclosure;

FIG. 5D depicts an example fourth state of the CRC lines, in accordance with some embodiments of the present disclosure;

FIG. 5E depicts an example fifth state of the CRC lines, in accordance with some embodiments of the present disclosure;

FIG. 5F depicts an example sixth state of the CRC lines, in accordance with some embodiments of the present disclosure;

FIG. 6 depicts an example method of computer architecture to valid image frame and image line data in a single pass, in accordance with some embodiments of the present disclosure; and

FIG. 7 depicts an example method of computer architecture to valid image frame and image line data in a single pass, in accordance with some embodiments of the present disclosure.

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure;

FIG. 8D is a system diagram for communication between cloud-based server(s) and the example autonomous vehicle of FIG. 8A, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

Camera image sensors can be used in automotive, robotics, smart city, surveillance, and/or other applications to generate values which can be used to verify the integrity of each camera frame and each line within the camera frame, including to generate CRC-32 values for each line and for each camera frame. In an aspect, checking integrity of received lines and frames involves a data consumer to also calculate a CRC for each line/frame and compare with that reported from the sensor. This can result in significant computational processing resource requirements. Further, using a CPU core for this integrity check results in a significant reduction in processing power which can be deployed for useful work. Thus, this technical solution can provide a technical improvement to accelerate the calculation of camera frame and line CRCs with a heavily parallel algorithm which can generate both frame and line CRCs in a single pass. Embodiments in accordance with this technical solution can use SIMD parallelism and can be implemented in an image processing digital signal processor (DSP). Thus, this technical solution can achieve at least the above noted results in a single pass using parallelization, beyond the capability that manual processes can achieve.

In an aspect, embodiments in accordance with this disclosure can operate according to CRC operations as discussed herein. However, this technical solution is not limited to the particular codes or particular transformations presented herein by way of example. In an aspect, the CRC operation is linear in GF(2). This means that for any two messages A and B, XOR(CRC(A), CRC(B))=CRC(XOR(A,B)). For example, leading zeroes have no effect on the CRC. If A′ is A with any number of zeros appended to the left, then CRC(A′)=CRC(A). Appending trailing zeroes to a message can be reduced to a modular multiplication with a precomputed constant value. For example, if A_n is the message A with n trailing zeros, then CRC(A_n)=modmult(CRC(A),b_n) where b_n is a precomputed constant specific to n.

In an aspect, an input image is processed in fixed sized tiles in a raster scan pattern, (tx, ty). Adequate memory can be reserved for tracking a CRC remainder for each of the rows in the tile height ty. A tile height can be chosen to both enable parallelism over the rows of the tile, and to hide the latency of lookup instructions. For example, a tile height of 64 can be chosen, allowing 16-way lane parallelism, and 4-way inner loop unrolling. This can provide a technical improvement to mask 6 cycle latency associated with lookups of data. Before processing a row of tiles, the systema can set one or more ty CRC remainders to zero. This system can customize initialization of CRC32 remainders to zero, from a default initialization to 0xFFFFFFFF. Setting remainders to zero provides a technical solution to later combine the remainder using CRC linearity. For example, the system can read n-bytes into each of the m SIMD lanes. Each lane comes from the next row in the tile. For each of the m-lanes, the system can convert the n-bytes into n lookups from n tables. Each lookup can correspond to a distinct SIMD instruction. Therefore, the system can generate or return m X n 32-bit results. The system can then return these results back to m remainders, one for each lane, via XOR reduction. Thus, the technical solution achieves a slice-by-n realized over m parallel lanes. In an aspect, each tile in a row of tiles is iterated in this way. At the end of a row of tiles, a number of CRC remainders corresponding to ty is generated. However, these values may not fit the definition of the row CRCs because the remainders were not initialized to 0xFFFFFFFF (or whatever is required for a given CRC specification). The system can convert the ty CRC remainders to equivalent CRCs ‘as if’ the system had initialized the remainders to 0xFFFFFFFF (or some other value). For example, if the system operates with the remainder 0xFFFFFFFF and cycles by the same number of 0s as there are bits in the row, a different 32-bit value can be generated. This 32-bit value can then be XORed with the result for each of the ty rows. Thus, this would be equivalent to seeding the ty remainders. Cycling a constant starting value by a constant number of zeros can itself cause reducing to a constant value. The system can thus precompute this ‘postconditioning’ value in advance. Thus, the system can generate ty correct row CRCs, and can reduce these ty CRCs to a single remainder for the ty rows, to achieve a technical solution to build up a frame CRC at the same time as the row CRCs and reduce use of computational resources and processing delay in the highly time-sensitive machine vision domain.

The present disclosure is directed at least to providing parallelized generation of error correction codes, including parallelized transmission and integration of error correction codes for image frame data and individual rows of the image frame data. A processor can include a plurality of processing components (e.g., processor cores, SIMD lanes, or allocated portions thereof) that can each obtain an error correction code based on a row of frame data. Each of the processing components can perform one or more logical operations (e.g., XOR operations) and bit operations (e.g., appending varying numbers of bits to a row) to combine parallelized error correction codes for multiple rows of a frame, into a valid error correction code for the frame across the multiple rows. For example, one or more error correction codes can be independently calculated in parallel, for each row of the frame. The processor can perform one or more actions corresponding to a particular type of encoding (e.g., a cyclic redundancy check or “CRC” encoding). For example, the processor can set a remainder for one or more rows of image frame data to a predetermined value. Thus, this technical solution can achieve a technical improvement at least to obtain valid row-level and frame-level encodings in a single pass, by parallel processing of CRCs as discussed herein.

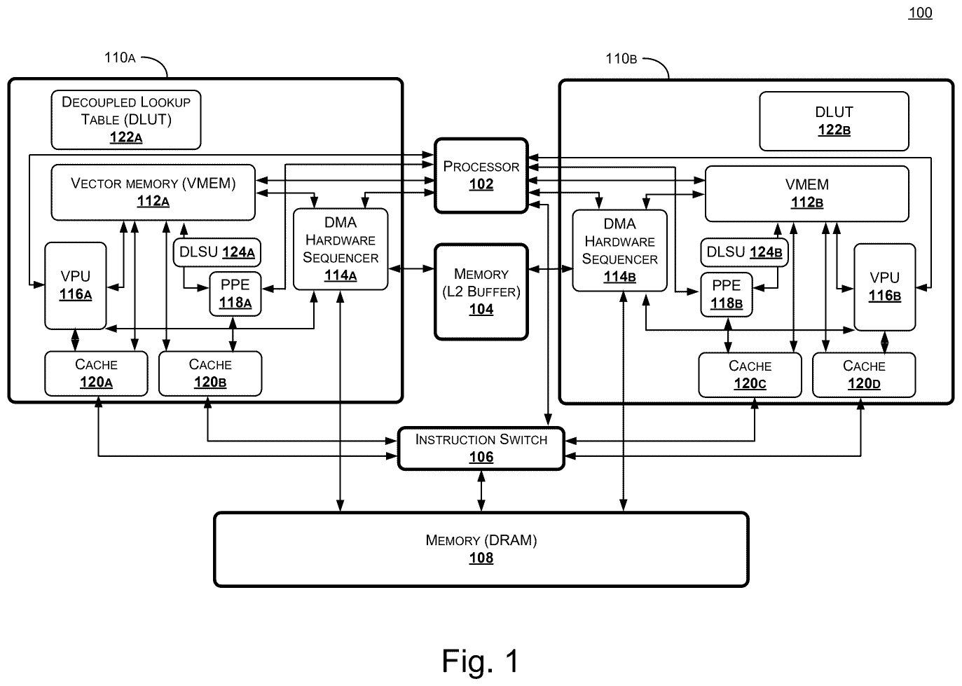

With reference to FIG. 1, the environment 100 can include processor 102, memory 104, instruction switch 106, memory 108 (sometimes referred to as dynamic random access memory or DRAM), and functional blocks 110a, 110b (referred to individually as functional block 110 and collectively as functional blocks 110 unless otherwise specified). In some embodiments, the processor 102, memory 104, instruction switch 106, memory 108, and functional blocks 110 can interconnect (e.g., establish a connection to communicate and/or the like) via wired and/or wireless connections. In some embodiments, the components of the environment 100 can be included in a system on a chip (SoC). For example, the components of the environment 100 can be included in one or more SoCs that form integrated circuits by combining some or all of the component of the environment 100.

The processor 102 can include one or more processors such as one or more central processing units (CPUs), graphical processing units (GPUs), microprocessors, microcontrollers, and/or the like. The processor 102 can interconnect with an instruction cache (not explicitly shown) that stores instructions for the processor 102 to execute. In some embodiments, the processor 102 can be configured to output data associated with configuration and/or control of one or more of the devices of FIG. 1. For example, the processor 102 can be configured to output data associated with configuration of a direct memory access (DMA) hardware sequencer 114a and/or DMA hardware sequencer 114b to control DMA transfers to and/or from vector memory (VMEM) 112a and/or VMEM 112b of functional block 110a and functional block 110b, respectively.

The memory 104 (sometimes referred to as an L2 buffer or L2 cache) can include a storage device that is interconnected with the DMA hardware sequencer 114a and/or the DMA hardware sequencer 114b of the functional blocks 110. In some embodiments, the memory 104 can be configured to receive and store data from the DMA hardware sequencer 114a and/or the DMA hardware sequencer 114b of the functional blocks 110 as described herein. In some embodiments, the memory 104 can have one or more (e.g., 2) banks that enable simultaneous read or write requests. For example, the memory 104 can have a first bank that is associated with the DMA hardware sequencer 114a and a second bank that is associated with the DMA hardware sequencer 114b.

The instruction switch 106 can include one or more processors that are configured to scan the memory 108, receive data from the memory 108, cause data stored in the memory 108 and/or in local memory to the instruction switch 106 to be loaded into the VMEM 112, and/or the like. For example, the instruction switch 106 can be coupled to the memory 108 and/or include internal memory that has stored thereon instructions involved in operating one or more of the devices of the corresponding functional blocks 110. In an example, the instruction switch 106 can be configuring to obtain and provide data associated with instructions to perform one or more DMA transfers as described herein. In another example, the instruction switch 106 can be configuring to obtain and provide data associated with instructions to perform one or more operations specific to one or more devices of the functional blocks 110. In an illustrative example, the instruction switch 106 can be configured to obtain and provide data associated with instructions to perform one or more filtering operations and the instruction switch 106 can transmit the data to caches 120 of corresponding functional units 110. In this illustrative example, the corresponding caches 120 can be configured to transmit (e.g., load) the data associated with the instructions into the VPU 116 or PPE 118 to cause the respective device to perform the one or more filtering operations.

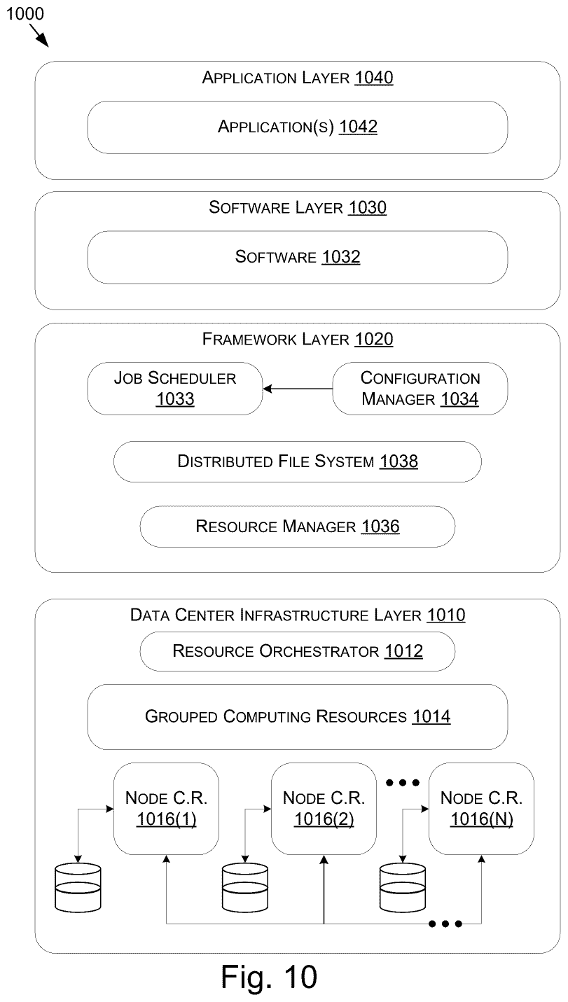

The memory 108 can include a storage device that is interconnected with the DMA hardware sequencer 114a and/or the DMA hardware sequencer 114b of the functional blocks 110. In some embodiments, the memory 108 can receive and store sensor data generated by one or more sensors of a robot such as, for example, the example autonomous vehicle of FIGS. 10A-10D. For example, during operation of the robot, the memory 108 can be configured to receive data based at least in part on a direct interconnection with the one or more sensors or an indirect interconnection with the one or more sensors (e.g., via communication through a CAN bus and/or the like). In these examples, the sensor data can include image data associated with one or more images generated by one or more cameras, LiDAR data associated with one or more LiDAR data associated with one or more point clouds generated by one or more LiDAR sensors, radar data associated with one or more radar images generated by one or more radar sensors, and/or the like. In some embodiments, the memory 108 can be configured to provide (e.g., transmit) the sensor data stored therein to one or more components of the functional blocks 110. For example, during processing of the one or more image generated by the one or more cameras of the robot, the DMA hardware sequencer 114a and/or DMA hardware sequencer 114b can obtain the image data from the memory 108 and cause the image data to be stored in the VMEM 112a and/or VMEM 112b, respectively. In some embodiments, the memory 108 can receive and store data from the DMA hardware sequencer 114a and/or the DMA hardware sequencer 114b of the functional blocks 110. For example, the DMA hardware sequencer 114a and/or DMA hardware sequencer 114b can provide image data that was updated based at least in part on the processing of the image data to the memory 108 and the memory 108 can store the image data that was updated in the memory 108.

Functional blocks 110 can include VMEMs 112a, 112b, DMA hardware sequencers 114a, 114b, vector processing units (VPUs) 116a, 116b, pixel processing engines (PPE) 118a, 118b, caches 120a, 120b, 120c, 120d, and decoupled lookup tables (DLUTs) 122a, 122b. For purposes of clarity, each will be referred to individually as VMEM 112, DMA hardware sequencer 114, VPU 116, PPE 118, cache 120, and DLUT 122, and collectively as VMEMs 112, DMA hardware sequencers 114, VPUs 116, PPEs 118, caches 120, and DLUTs 122 unless otherwise specified. While certain interconnections are illustrated, it will be understood that the connections illustrated are for simplicity and that one or more of the devices of the functional blocks 110 can interconnect with one or more other devices of the functional blocks 110 unless expressly stated otherwise.

The VMEMs 112 can include a storage device that is interconnected with the processor 102 and the respective DMA hardware sequencers 114, VPUs 116, PPEs 118, and caches 120 of the functional blocks 110. In some embodiments, the VMEMs 112 can receive and store the sensor data obtained from the memory 108. For example, the VMEMs 112 can receive and store the sensor data obtained from the memory 108 by the DMA hardware sequencers 114. Additionally, or alternatively, VMEMs 112 can receive and store the sensor data obtained from the memory 108 via the instruction switch 106. In some embodiments, the VMEMs 112 can interconnect with the PPEs 118 via decoupled load/store units (DLSUs) 124. As described herein, the DLSUs 124 can be configured to buffer data communicated between the VMEMs 112 and the PPEs 118 to reduce latencies associated with communication between the VMEMs 112 and the PPEs.

The DMA hardware sequencers 114 can include one or more processors that control the execution of one or more instructions. For example, the DMA hardware sequencers 114 can receive instructions from the processor 102, the respective VPUs 116 or PPEs 118, and/or a storage device (e.g., a device associated with the DMA hardware sequencers 114 such as internal or external memory, not explicitly shown) and the DMA hardware sequencers 114 can coordinate with the respective VPUs 116 and/or the PPEs 118 to perform one or more operations during execution of the instructions. In one illustrative example, the DMA hardware sequencers 114 can receive instructions that cause the DMA hardware sequencers 114 to obtain data (e.g., sensor data and/or the like) from the memory 108 and store the data in the respective VMEMs 112. In some embodiments, the DMA hardware sequencers 114 can perform one or more operations based at least in part on the data obtained from the memory 108. For example, the DMA hardware sequencers 114 can pad frames (e.g., image frames), manipulate addresses, manage overlapping data, manage different traversal orders, account for different frame sizes, and/or the like. In some embodiments, the DMA hardware sequencers 114 can receive signals (e.g., from the VPUs 116 or PPEs 118) indicating that one or more operations were performed on the data stored in the VMEMs 112, update one or more descriptors based at least in part on the updates to the data, and again perform operations on the data.

The VPUs 116 can include one or more processors that execute one or more instructions. For example, the VPUs 116 can receive instructions from the processor 102 and the respective VPUs 116 can coordinate with the DMA hardware sequencers 114 and/or PPEs 118 to perform the one or more operations during execution of the instructions. In one illustrative example, the VPUs 116 can receive instructions from the processor 102 that cause the VPUs 116 to trigger respective DMA hardware sequencers 114 to obtain sensor data from the memory 108 and store the sensor data in the respective VMEMs 112. In examples, the VPUs 116 can process the data stored in the respective VMEMs 112 and write data back to the VMEMs 112. In these examples, the data written by the VPUs 116 into respective VMEMs 112 can include updated sensor data and/or data generated based at least in part on analysis performed by the VPUs 116 on the sensor data, including object or feature locations within a frame, a classification indicating a type of an object or agent, and/or the like. In some embodiments, the VPUs 116 can provide (e.g., send, transmit, transfer, etc.) a signal to the respective DMA hardware sequencers 114 to cause the DMA hardware sequencers 114 to update one or more descriptors (described herein). For example, the VPUs 116 can send a signal to the respective DMA hardware sequencers 116 to cause the DMA hardware sequencers 114 to update one or more descriptors based at least in part on the data written by the VPUs 116 to the respective VMEMs 112.

The PPEs 118 can include one or more processors that execute one or more instructions. For example, the PPEs 118 can receive instructions from the processor 102 and the respective PPEs 118 can coordinate with the DMA hardware sequencers 114 and/or VPUs 116 to perform the one or more operations during execution of the instructions. In one illustrative example, the PPEs 118 can receive instructions from the processor 102 that cause the PPEs 118 to trigger respective DMA hardware sequencers 114 to obtain (e.g., receive, acquire, capture, etc.) sensor data from the memory 108 and store the sensor data in the respective VMEMs 112. In examples, the PPEs 118 can process the data stored in the respective VMEMs 112 and write data back to the VMEMs 112. In these examples, the data written by the PPEs 118 into respective VMEMs 112 can include updated sensor data and/or data generated based at least in part on analysis performed by the PPEs 118 on the sensor data, including object or feature locations within a frame, a classification indicating a type of an object or agent, and/or the like. In some embodiments, the PPEs 118 can send a signal to the respective DMA hardware sequencers 114 to cause the DMA hardware sequencers 114 to update one or more descriptors (described herein). For example, the PPEs 118 can send a signal to the respective DMA hardware sequencers 114 to cause the DMA hardware sequencers 114 to update one or more descriptors based at least in part on the data written by the PPEs 118 to the respective VMEMs 112.

The caches 120 can include a storage device that is interconnected with the VMEMs 112 and/or the instruction switch 106. As noted above, the caches 120 can receive data associated with instructions from the instruction switches 106 and load the instructions into one or more devices of the functional blocks 110 to cause the one or more devices to operate in accordance with the instructions. The DLUTs 122 can include a processor and/or memory configured to store one or more lookup tables. In some embodiments, the DLUTs 122 can be configured to enable communication between the processor 102 and one or more components of the functional blocks 110. For example, the DLUTs 122 can be configured to be in communication with the processor 102 and/or one or more memory devices of FIG. 1 (e.g., the memory 108 and/or the memory 104). The DLUT 122 can then manage the data storage and retrieval process between the processor 102 and the one or more memory devices of FIG. 1. The DLSUs 124 can include a storage device that is interconnected with the VMEMs 112 and PPEs 118 of a given functional block 110. For example, the DLSUs 124 can receive and store the sensor data obtained by the VMEMs 112 from the memory 108. Additionally, or alternatively, the DLSUs 124 can receive and store the data provide as an output by the PPEs 118.

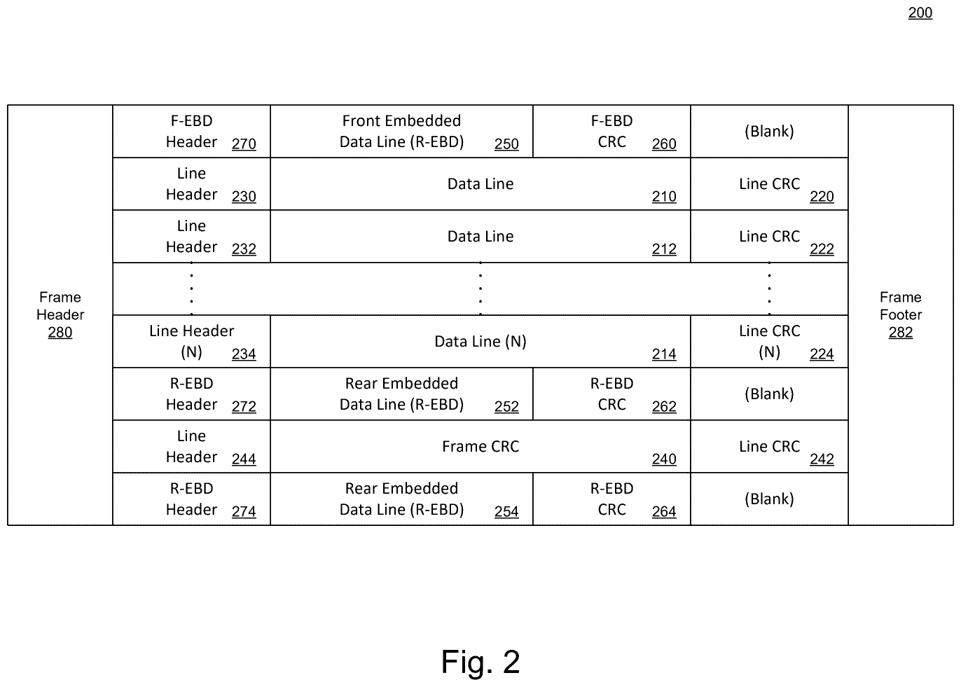

FIG. 2 depicts an example frame data structure, according to this disclosure. As illustrated by way of example in FIG. 2, a frame data structure 200 can include at least data lines 210, 212 and 214, a frame CRC 240, a front embedded data line 250, rear embedded data lines 252 and 254, a frame header 280, and a frame footer 282. One or more of the VMEM 112A-B, the cache 120A-D, the VPU 116A-B, the PPE 118A-B, the memory 104, or the memory 108 can receive transmit or store the frame data structure 200, but frame data structure 200 is not limited to the above-noted components.

The data lines 210, 212 and 214 can each store data indicative of a corresponding distinct line or row of image data. For example, the data lines 210, 212 and 214 can each store data of one or more adjacent and horizontal pixels of an image. The data lines 210, 212 and 214 can include or be linked with corresponding line CRCs 220, 222 and 224 and corresponding line headers 230, 232 and 234. The line CRCs 220, 222 and 224 can each indicate a distinct CRC corresponding to the corresponding one of the data lines 210, 212 and 214. For example, the line CRC 220 can correspond to the data line 210, the line CRC 222 can correspond to the data line 212, and the line CRC 224 can correspond to the data line 214. The line headers 230, 232 and 234 can each indicate a distinct identifier corresponding to the corresponding one of the data lines 210, 212 and 214. For example, the line header 230 can correspond to the data line 210, the line header 232 can correspond to the data line 212, and the line header 234 can correspond to the data line 214. For example, one or more of the line headers 230, 232 and 234.

The frame CRC 240 can indicate a distinct CRC corresponding to a plurality of the data lines 210, 212, and 214. For example, the frame CRC 240 can be based on all of the data lines 210, 212, and 214, or a subset including one or more thereof. The frame CRC 240 can include a line CRC 242, and a line header 244. The line CRC 242 can indicate a distinct CRC corresponding to the frame CRC 240. The line header 244 can indicate a distinct identifier corresponding to the frame CRC 240. The front embedded data line 250 can include data indicative of image data, but is not limited to image content. For example, the front embedded data line 250 can include image format data, metadata, descriptive data, or any combination thereof, directed to a frame. The front embedded data line 250 can include a front embedded CRC 260, and a front embedded header 270. The front embedded CRC 260 can indicate a distinct CRC corresponding to a plurality of the front embedded data lines 250. The front embedded header 270 can indicate a distinct identifier corresponding to the front embedded data line 250. The rear embedded data lines 252 and 254 can include data indicative of image data, but is not limited to image content. The rear embedded data lines 252 and 254 can each correspond at least partially in one or more of structure and operation to the front embedded data line 250, and can include content distinct from each other and from the front embedded data line 250. For example, the rear embedded data lines 252 and 254 can each include image format data, metadata, descriptive data, or any combination thereof, directed to a frame. For example, data can be distributed across at least a portion of the front embedded data line 250 and the rear embedded data lines 252 and 254. The rear embedded data lines 252 and 254 can each include respective rear embedded CRCs 262 and 264, and respective rear embedded headers 272 and 274. The rear embedded CRCs 262 and 264 can each indicate a distinct CRC for the corresponding rear embedded data lines 252 and 254. The rear embedded headers 272 and 274 can each indicate a distinct identifier corresponding to the rear embedded data lines 252 and 254.

The frame header 280 can include data indicative of image data, but is not limited to image content. For example, the front embedded data line 250 can image format data, metadata (e.g., EXIF data), descriptive data, or any combination thereof, directed to a plurality of frame. For example, the frame header 280 can include a transmission instruction to identify a parameter for transmission (e.g., bandwidth). For example, one or more of the line headers 230, 232, and 234 can include a routing instruction to identify a parameter for routing (e.g., destination). For example, the frame header 280 can indicate a start of a given frame corresponding to the frame data structure 200. The frame footer 282 can correspond at least partially to one or more of structure and operation to the frame header 280. For example, the frame footer 282 can indicate an end of a given frame corresponding to the frame data structure 200.

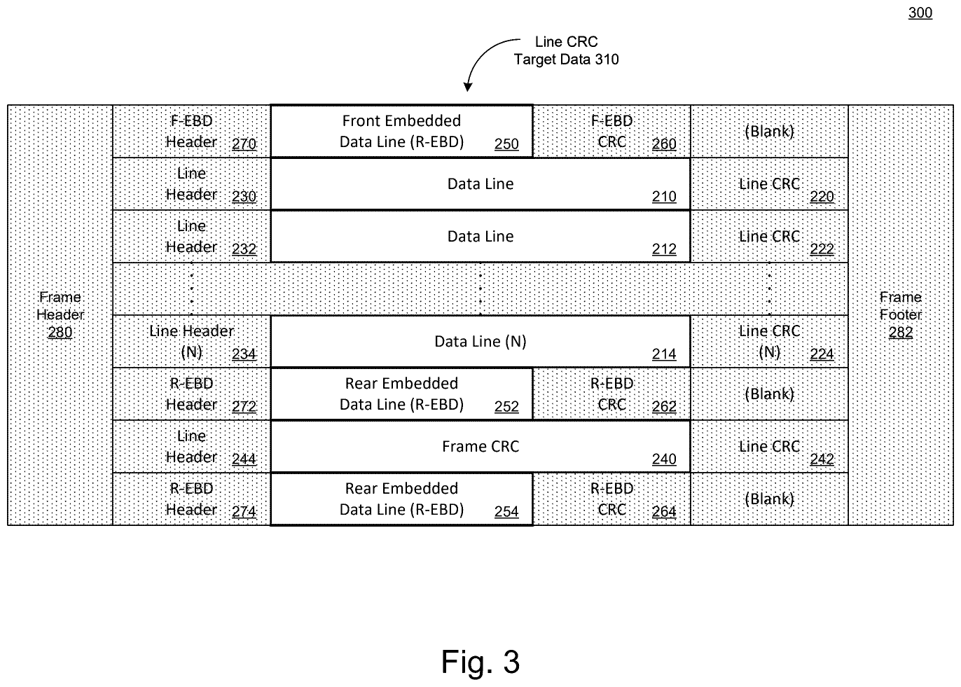

FIG. 3 depicts an example architecture of line CRC input data structures, according to this disclosure. As illustrated by way of example in FIG. 3, an architecture of line CRC input data structures 300 can include at least line CRC target data 310. In an aspect, a subset of fields of the frame data structure 200, corresponding to the line CRC target data 310, can be used to generate one or more of the line CRCs 220, 222, and 224. The line CRC target data 310 can include the data lines 210, 212, and 214, the frame CRC 240, the front embedded data line 250, the rear embedded data lines 252 and 254. In an aspect, the line CRC target data 310 can include varying subsets of fields for each data line of the data lines 210, 212, and 214. For example, the line CRC target data 310 for the data line 210 can include the data line 210, the frame CRC 240, the front embedded data line 250, the rear embedded data lines 252 and 254, and can exclude the data lines 212 and 214. For example, the line CRC target data 310 for the data line 212 can include the data line 212, the frame CRC 240, the front embedded data line 250, the rear embedded data lines 252 and 254, and can exclude the data lines 210 and 214. For example, the line CRC target data 310 for the data line 214 can include the data line 212, the frame CRC 240, the front embedded data line 250, the rear embedded data lines 252 and 254, and can exclude the data lines 210 and 212.

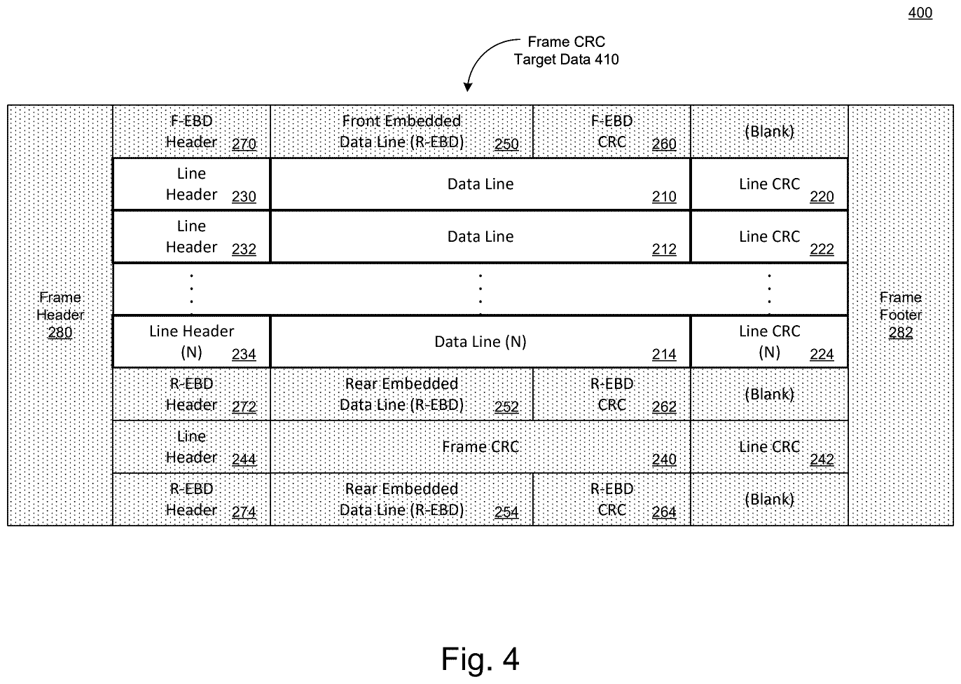

FIG. 4 depicts an example architecture of frame CRC input data structures, according to this disclosure. As illustrated by way of example in FIG. 4, an architecture 400 of frame CRC input data structures can include at least frame CRC target data 410. In an aspect, a subset of fields of the frame data structure 200, corresponding to the frame CRC target data 410, can be used to generate the frame CRC 240. The frame CRC target data 410 can include the data lines 210, 212 and 214, the line CRCs 220, 222 and 224, and the line header 230, 232 and 234.

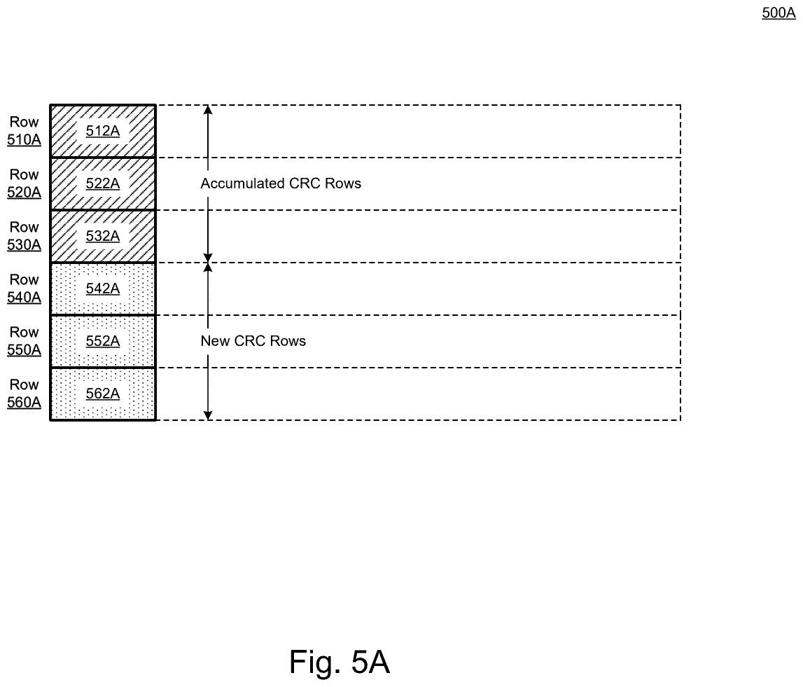

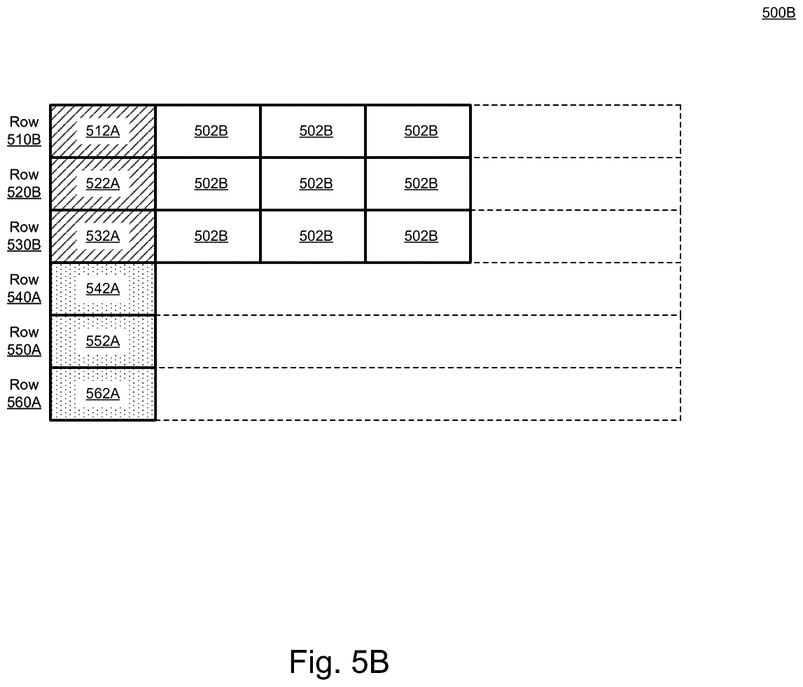

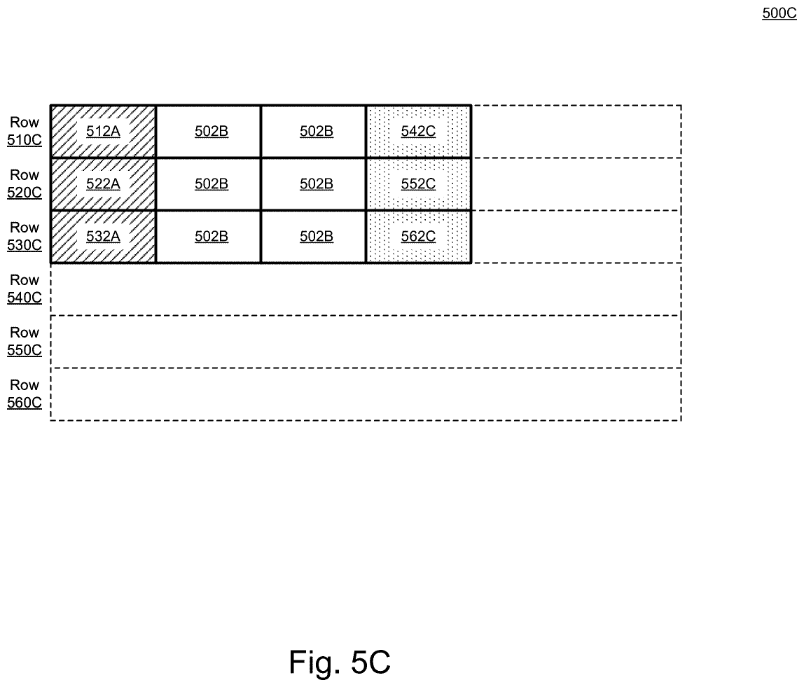

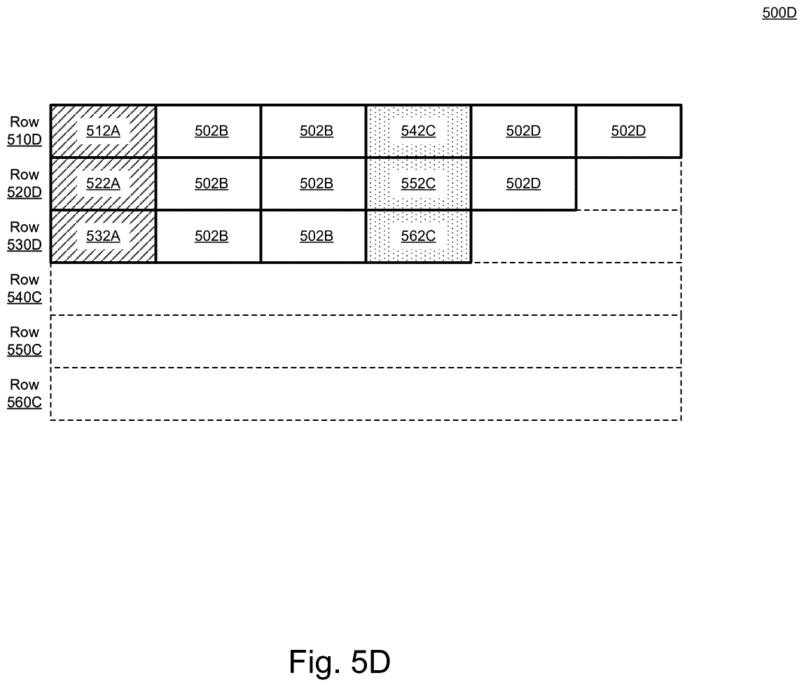

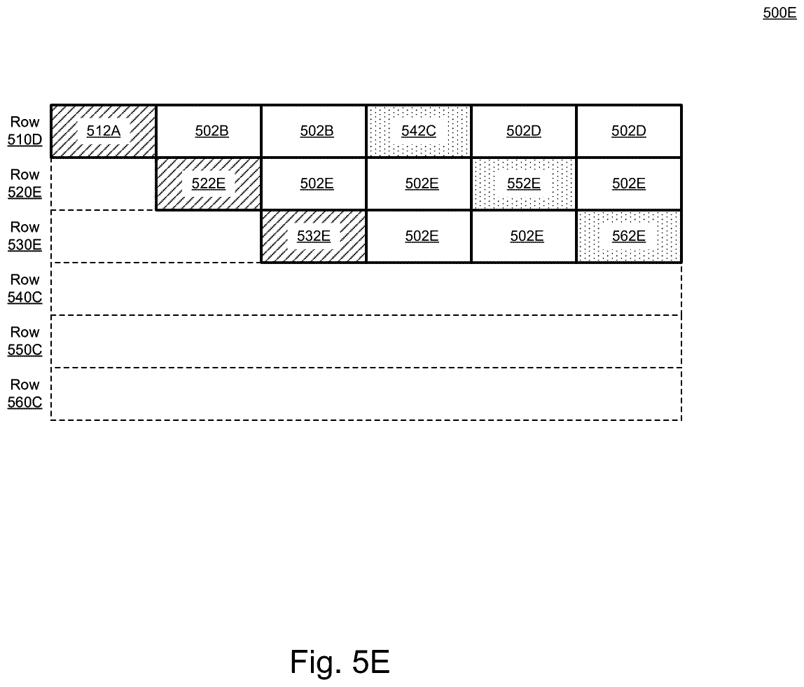

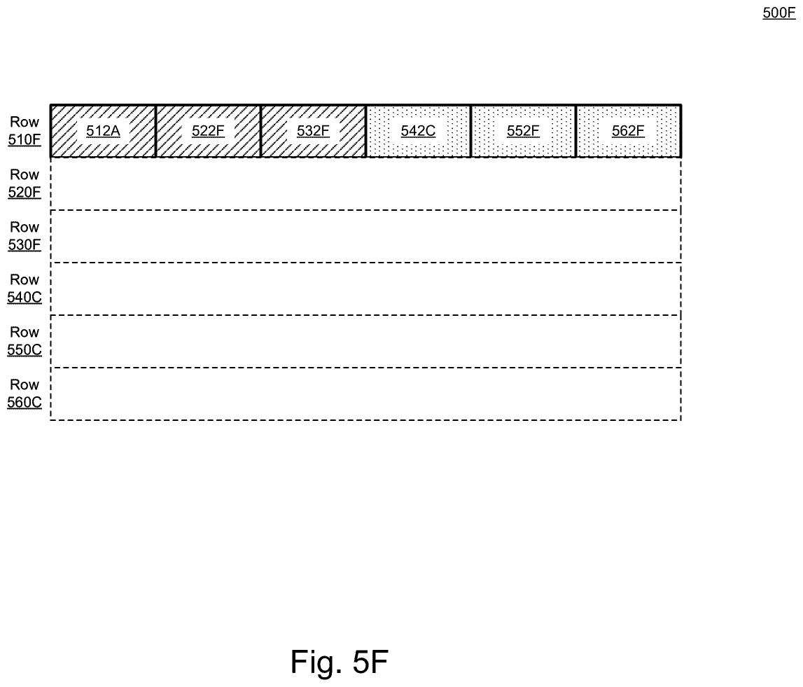

FIGS. 5A-F are directed to combining sequential rows together to create a frame CRC according to the architecture 400, based on the ty CRCs calculated without preconditioning (i.e., remainders initialized to 0). First, at the end of each tile row, the system can combine the ty current CRCs with ty accumulated remainders of CRCs from the previous tile rows. For example, the remainders can be initialized to zeros for operations on the first tile row. Second, at the end of all tile rows, the system can combine the ty accumulated remainders to a single CRC value.

In a first sequence, for each of the ty accumulated CRCs, the system can cycle by (ty-1)*row_width zero bytes (e.g., corresponding to zero blocks as discussed herein). For example, the cycling can be a constant-time modular multiplication operation. The modular multiplication may be applied to all rows in parallel using SIMD instructions. This can be equivalent to calculating a CRC for the row appended with enough zeros to contain an entire block of data. Then, the system can XOR each of the ty accumulated CRCs with the ty CRCs for the current tile row, at the end of each tile row. In a subsequent sequence, for each zero-based index i in the ty accumulated CRCs, the system can cycle by (ty-i-1)*row_width zero bytes. For example, the cycling can be a constant-time modular multiplication operation. The modular multiplication may be applied to all rows in parallel using SIMD instructions. This is the equivalent of applying a variable number of zeros to each row. Then, the system can XOR reduce all the results to a single, final CRC. FIGS. 5A-F illustrate an example of the above-noted sequences, for an example an image four bytes wide, processed in tiles of 4×3. After processing the first tile row, the system can initialize the accumulators to the value of the first row CRCs. After processing the second tile row, the system can apply the first sequence above to accumulate the new CRCs onto the accumulators. This manipulation in the CRC domain is the equivalent of reserving large blocks of ‘zeros’ in the image domain.

FIG. 5A depicts an example first state of CRC lines, according to this disclosure. As illustrated by way of example in FIG. 5A, a first state of CRC lines 500A can include at least a CRC line of a first row 510A, a CRC line of a second row 520A, a CRC line of a third row 530A, a CRC line of a fourth row 540A, a CRC line of a fifth row 550A, and a CRC line of a sixth row 560A.

The CRC line 510A of the first row can correspond at least partially in one or more of structure and operation to a first line CRC among the line CRCs 220, 222 and 224. The CRC line of the first row 510A can include a first accumulated CRC data 512A. The first accumulated CRC data 512A can correspond to first data derived from other frame data of the frame architecture 200. For example, the first accumulated CRC data 512A can correspond to a first remainder of a given collection of one or more CRCs associated with a first set of data lines. The CRC line 520A of the second row can correspond at least partially in one or more of structure and operation to a second line CRC among the line CRCs 220, 222 and 224. The CRC line 520A of the second row can include a second accumulated CRC data 522A. The second accumulated CRC data 522A can correspond to second data derived from other frame data of the frame architecture 200. For example, the second accumulated CRC data 522A can correspond to a second remainder of a given collection of one or more CRCs associated with a second set of data lines. The CRC line of a third row 530A can correspond at least partially in one or more of structure and operation to a third line CRC among the line CRCs 220, 222 and 224. The CRC line of a third row 530A can include a third accumulated CRC data 532A. The third accumulated CRC data 532A can correspond to third data derived from other frame data of the frame architecture 200. For example, the third accumulated CRC data 532A can correspond to a third remainder of a given collection of one or more CRCs associated with a third set of data lines.

The CRC line 540A of the fourth row can correspond at least partially in one or more of structure and operation to a fourth line CRC among the line CRCs 220, 222 and 224. The CRC line 540A of the fourth row can include a first new CRC data 542A. The first new CRC data 542A can correspond to first data derived from a single data line of the frame architecture 200. For example, the first new CRC data 542A can correspond to a first CRC derived exclusively from a fourth data line of the data lines 210, 212, and 214. The CRC line of a fifth row 550A can correspond at least partially in one or more of structure and operation to a fifth line CRC among the line CRCs 220, 222, and 224. The CRC line 550A of the fifth row can include a second new CRC data 552A. The second new CRC data 552A can correspond to second data derived from a single data line of the frame architecture 200. For example, the second new CRC data 552A can correspond to a second CRC derived exclusively from a fifth data line of the data lines 210, 212, and 214. The CRC line of a sixth row 560A can correspond at least partially in one or more of structure and operation to a sixth line CRC among the line CRCs 220, 222, and 224. The CRC line of a sixth row 560A can include a third new CRC data 562A. The third new CRC data 562A can correspond to third data derived from a single data line of the frame architecture 200. For example, the third new CRC data 562A can correspond to a third CRC derived exclusively from a sixth data line of the data lines 210, 212, and 214.

FIG. 5B depicts an example second state of the CRC lines, according to this disclosure. As illustrated by way of example in FIG. 5B, a second state of the CRC lines 500B can include at least a CRC line of the first row 510B, a CRC line of the second row 520B, and a CRC line of the third row 530B. The CRC line 510B of the first row can include the first accumulated CRC data 512A and a first plurality of zero blocks 502B. The first plurality of zero blocks 502B can have a length corresponding to the CRC data 512, 522, 532, 542, 552, and 562. For example, the zero blocks 502B can have a length of four bits, where each bit is zero (e.g., “0000”). For example, the CRC line 510B of the first row can include three of the zero blocks 502B appended to the right of the first accumulated CRC data 512A. The CRC line 520B of the second row can include the second accumulated CRC data 522A and a second plurality of the zero blocks 502B. The second plurality of zero blocks 502B can have the length corresponding to the CRC data 512, 522, 532, 542, 552, and 562. For example, the zero blocks 502B can have a length of four bits, where each bit is zero (e.g., “0000”). For example, the CRC line 520B of the second row can include three of the zero blocks 502B appended to the right of the second accumulated CRC data 522A. The CRC line of the third row 530B can include the third accumulated CRC data 532A and a third plurality of the zero blocks 502B. The third plurality of zero blocks 502B can have the length corresponding to the CRC data 512, 522, 532, 542, 552, and 562. For example, the zero blocks 502B can have a length of four bits, where each bit is zero (e.g., “0000”). For example, the CRC line 530B of the third row can include three of the zero blocks 502B appended to the right of the third accumulated CRC data 532A.

FIG. 5C depicts an example third state of the CRC lines, according to this disclosure. As illustrated by way of example in FIG. 5C, a third state of the CRC lines 500C can include at least a CRC line of the first row 510C, a CRC line of the second row 520C, a CRC line of the third row 530C, a CRC line of a fourth row 540C, a CRC line of a fifth row 550C, and a CRC line of a sixth row 560C.

The CRC line 510C of the first row can include the first accumulated CRC data 512A, the first plurality of zero blocks 502B, and the first new CRC data 542C. The first new CRC data 542C can correspond at least partially in one or more of structure and operation to the first new CRC data 542A that has been transferred to the CRC line 510C and appended to the right of the first plurality of zero blocks 502B. The CRC line 520C of the second row can include the second accumulated CRC data 522A, the second plurality of zero blocks 502B, and the second new CRC data 552C. The second new CRC data 552C can correspond at least partially in one or more of structure and operation to the second new CRC data 552A that has been transferred to the CRC line 520C and appended to the right of the second plurality of zero blocks 502B. The CRC line 530C of the third row can include the third accumulated CRC data 532A, the third plurality of zero blocks 502B, and the third new CRC data 562C. The third new CRC data 562C can correspond at least partially in one or more of structure and operation to the third new CRC data 562A that has been transferred to the CRC line 530C and appended to the right of the third plurality of zero blocks 502B.

The CRC line 540C of the fourth row can correspond at least partially in one or more of structure and operation to the CRC line 540A of the fourth row, and can correspond to an empty state after transfer of the first new CRC data 542A to the CRC line 510C as the first new CRC data 542C. The CRC line 550C of the fifth row can correspond at least partially in one or more of structure and operation to the CRC line 550A of the fifth row, and can correspond to an empty state after transfer of the second new CRC data 552A to the CRC line 520C as the second new CRC data 552C. The CRC line 560C of the sixth row can correspond at least partially in one or more of structure and operation to the CRC line 560A of the sixth row, and can correspond to an empty state after transfer of the third new CRC data 562A to the CRC line 530C as the third new CRC data 562C.

FIG. 5D depicts an example fourth state of the CRC lines, according to this disclosure. As illustrated by way of example in FIG. 5D, a fourth state of the CRC lines 500D can include at least a CRC line of the first row 510D, a CRC line of the second row 520D, and a CRC line of the third row 530D. The CRC line 510D of the first row can include the first accumulated CRC data 512A, the first plurality of zero blocks 502B, the first new CRC data 542C, and a plurality of zero blocks 502D. Each of the plurality of zero blocks 502D can correspond at least partially in one or more of structure and operation to the zero blocks 502D. The CRC line 520D of the second row can include the second accumulated CRC data 522A, the second plurality of zero blocks 502B, the second new CRC data 552C, and a zero block 502D. The CRC line 530D of the third row can include the third accumulated CRC data 532A, the third plurality of zero blocks 502B, the third new CRC data 562C, and no zero blocks 502D. Thus, the zero blocks 502D appended to each of the lines 51D-520D can vary by line.

FIG. 5E depicts an example fifth state of the CRC lines, according to this disclosure. As illustrated by way of example in FIG. 5E, a fifth state of the CRC lines 500E can include at least a shifted CRC line of the second row 520E, and a shifted CRC line of the third row 530E. The shifted CRC line 520E of the second row can include shifted zero blocks 502E, shifted zero blocks 502E, a shifted second accumulated CRC data 522E, and a shifted second new CRC data 552E. For example, each of the above-noted blocks can be shifted four bits corresponding to the unallocated memory space at the end of the CRC line 520D. The shifted CRC line of the third row 530E can include a shifted third accumulated CRC data 532E, and a shifted third new CRC data 562E. For example, each of the above-noted blocks can be shifted eight bits corresponding to the unallocated memory space at the end of the CRC line 520D.

FIG. 5F depicts an example sixth state of the CRC lines, according to this disclosure. As illustrated by way of example in FIG. 5F, a sixth state of the CRC lines 500F can include at least a CRC line of the first row 510F, a CRC line of the second row 510F, a CRC line of the third row 510F, a CRC line of the fourth row 510F, a CRC line of the fifth row 510F, and a CRC line of the sixth row 510F. The CRC line of the first row 510F can include the first accumulated CRC data 512A, a reduced second accumulated CRC data 522F, a reduced third accumulated CRC data 532F, the first new CRC data 542C, a reduced second new CRC data 552F, and a reduced third new CRC data 562F. The reduced second accumulated CRC data 522F can correspond at least partially in one or more of structure and operation to the second accumulated CRC data 522A shifted into the row 510F. The reduced third accumulated CRC data 532F can correspond at least partially in one or more of structure and operation to the third accumulated CRC data 532A shifted into the row 510F. The reduced second new CRC data 552F can correspond at least partially in one or more of structure and operation to the second new CRC data 552A shifted into the row 510F.The reduced third new CRC data 562F can correspond at least partially in one or more of structure and operation to the third new CRC data 562A shifted into the row 510F. In an aspect, the CRCs for rows 4, 5, and 6 do not need to be cycled, because leading zeroes have no effect on the CRC as discussed above. When all tile rows are complete, the system can combine the ty accumulators to a single value. Thus, this technical solution can provide a technical improvement to leverage constant time operations to create ‘holes’ in the image domain (e.g., corresponding to zero blocks 502B and 502D). Each hole can be sized to be filled by one of the other CRCs during final XOR reduction. The final XOR reduction across parallel accumulators can be deferred until all tiles have been processed, allowing the system to achieve the frame-level CRC in a single reduction.

The CRC line of the second row 520F can include no CRCs, as all CRCs have been shifted into the row 510F by an XOR operation with corresponding bits of the row 510F. The CRC line of the second row 520F can include no zero blocks, as all zero blocks have been eliminated by the XOR operation with the corresponding bits of the row 510F. The CRC line of the third row 530F can include no CRCs, as all CRCs have been shifted into the row 510F by an XOR operation with corresponding bits of the row 510F. The CRC line of the third row 530F can include no zero blocks, as all zero blocks have been eliminated by the XOR operation with the corresponding bits of the row 510F. The CRC line of the fourth row 510F can include no CRCs, as all CRCs have been shifted into the row 510F by an XOR operation with corresponding bits of the row 510F. The CRC line of the fourth row 540F can include no zero blocks, as all zero blocks have been eliminated by the XOR operation with the corresponding bits of the row 510F. The CRC line of the fifth row 510F can include no CRCs, as all CRCs have been shifted into the row 510F by an XOR operation with corresponding bits of the row 510F. The CRC line of the fifth row 550F can include no zero blocks, as all zero blocks have been eliminated by the XOR operation with the corresponding bits of the row 510F. The CRC line of the sixth row 510F can include no CRCs, as all CRCs have been shifted into the row 510F by an XOR operation with corresponding bits of the row 510F. The CRC line of the sixth row 560F can include no zero blocks, as all zero blocks have been eliminated by the XOR operation with the corresponding bits of the row 510F.

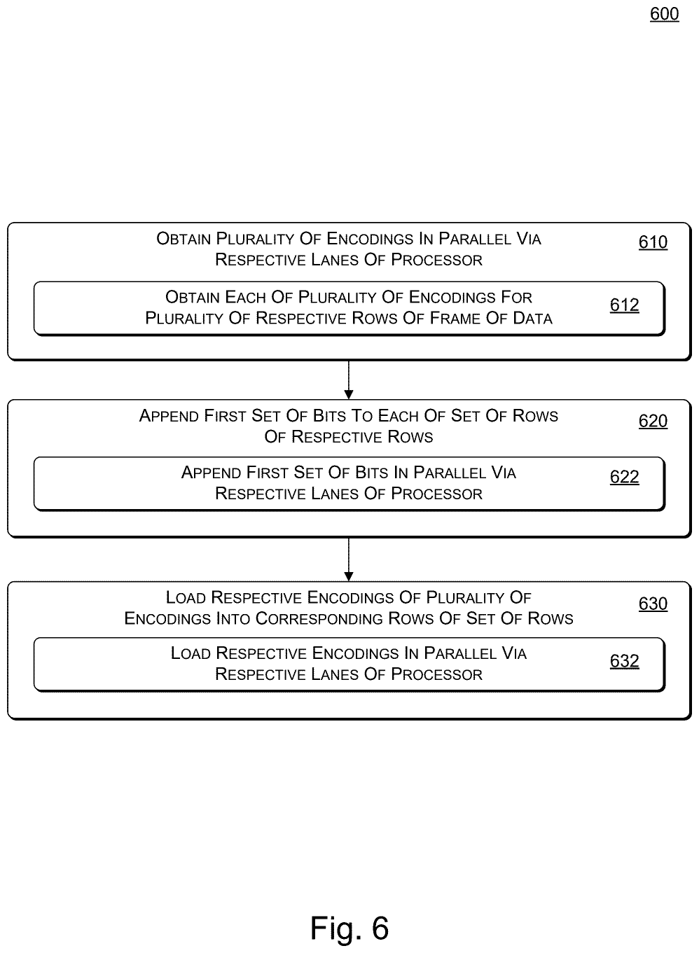

FIG. 6 depicts an example method to obtain valid image frame and image line data in a single pass, according to this disclosure. At least the system 100 can perform method 600. In an aspect, the method can include initializing each of the plurality of encodings with a remainder having a value corresponding to zero. In an aspect, the method 100 can initialize each of the plurality of encodings with a remainder having a value corresponding to zero. At 610, the method 600 can obtain a plurality of encodings in parallel via respective lanes of a processor. At 612, the method 600 can obtain each of the plurality of encodings for a plurality of respective rows of a frame of data. At 620, the method 600 can append a first set of bits to each of a set of rows of the respective rows. At 622, the method 600 can append the first set of bits in parallel via the respective lanes of the processor.

At 630, the method 600 can load respective encodings of the plurality of encodings into corresponding rows of the set of rows. In an aspect, the method can include loading the respective encodings of the plurality of encodings by a first XOR operation. In an aspect, the system can load the respective encodings of the plurality of encodings by a first XOR operation. In an aspect, the method can include loading each of the encodings each of the set of rows into the common row by a second XOR operation subsequent to the first XOR operation. In an aspect, the system can load each of the encodings each of the set of rows into the common row by a second XOR operation subsequent to the first XOR operation. At 632, the method 600 can load the respective encodings in parallel via the respective lanes of the processor. In an aspect, the method can include loading, in parallel via the respective lanes of the processor, respective second encodings of the plurality of encodings into corresponding rows of the set of rows. In an aspect, the system can load, in parallel via the respective lanes of the processor, respective second encodings of the plurality of encodings into corresponding rows of the set of rows.

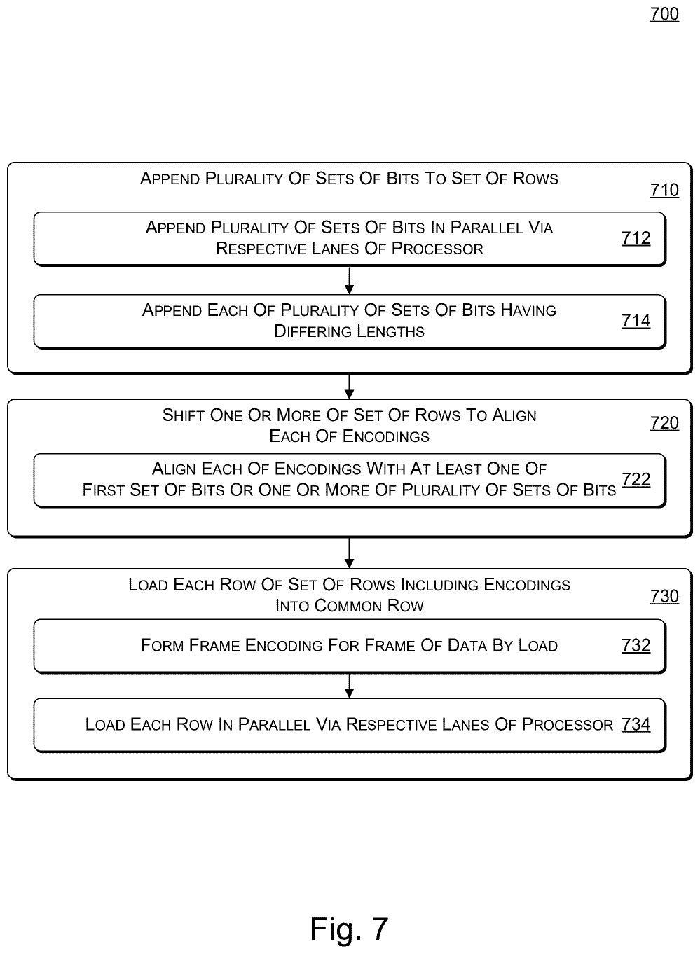

FIG. 7 depicts an example method to obtain valid image frame and image line data in a single pass, according to this disclosure. At least system 100 can perform method 700. At 710, the method 700 can append a plurality of sets of bits to the set of rows. At 712, the method 700 can append the plurality of sets of bits in parallel via the respective lanes of the processor. At 714, the method 700 can append each of the plurality of sets of bits having differing lengths. In an aspect, the method can include determining a length of the first set of bits based on a length of each of the plurality of encodings. In an aspect, the system can determine a length of the first set of bits based on a length of each of the plurality of encodings. In an aspect, the method can include determining the differing lengths of each of the plurality of sets of bits, based on a width corresponding to the respective rows, a height of the frame of the data, and respective indices of each of the respective rows. In an aspect, the system can determine the differing lengths of each of the plurality of sets of bits, based on a width corresponding to the respective rows, a height of the frame of the data, and respective indices of each of the respective rows. At 720, the method 700 can shift one or more of the set of rows to align each of the encodings. At 722, the method 700 can align each of the encodings with at least one of the first set of bits or one or more of the plurality of sets of bits. At 730, the method 700 can load each row of the set of rows including the encodings into a common row. At 732, the method 700 can form a frame encoding for the frame of the data by the load. At 734, the method 700 can load each row in parallel via the respective lanes of the processor. In an aspect, the plurality of encodings corresponds to error correction codes according to a cyclic redundancy check (CRC) format. In an aspect, the respective lanes each correspond to single-instruction multiple-data (SIMD) lanes of the processor. In an aspect, the system can generate the second encodings. The system can generate the first encodings subsequent to generation of the second encodings.

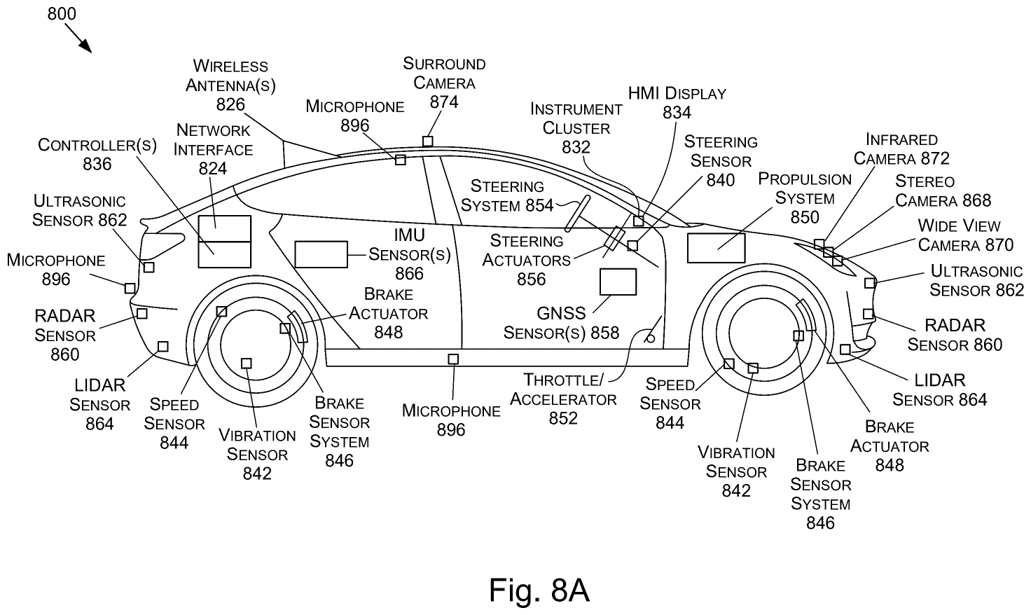

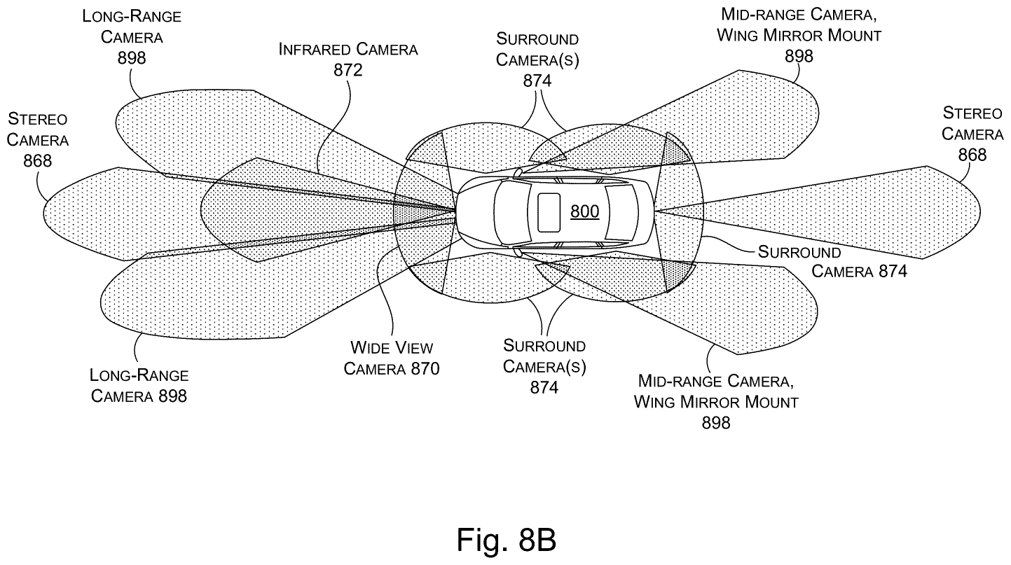

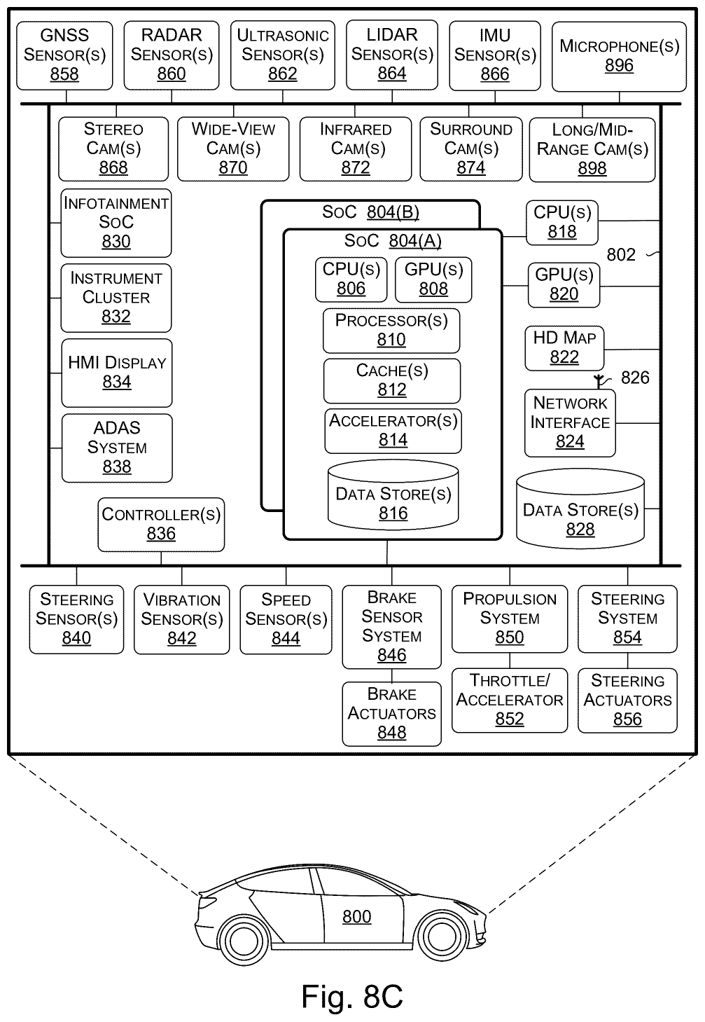

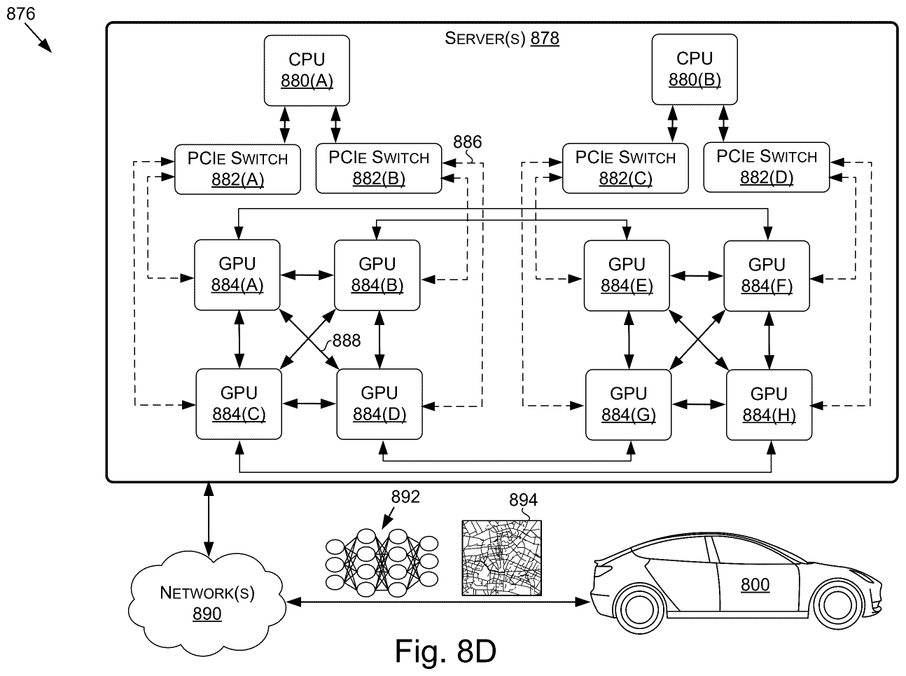

FIG. 8A is an illustration of an example autonomous vehicle 800, in accordance with some embodiments of the present disclosure. The autonomous vehicle 800 (alternatively referred to herein as the “vehicle 800”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 may be capable of functionality in accordance with one or more of Level 3-Level 5 of the autonomous driving levels. The vehicle 800 may be capable of functionality in accordance with one or more of Level 1-Level 5 of the autonomous driving levels. For example, the vehicle 800 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 800 or other machine, such as being fully autonomous, being highly autonomous, being conditionally autonomous, being partially autonomous, providing assistive autonomy, being semi-autonomous, being primarily autonomous, or other designation.

The vehicle 800 may include components such as a chassis, a vehicle body, wheels (e.g., 2, 4, 6, 8, 18, etc.), tires, axles, and other components of a vehicle. The vehicle 800 may include a propulsion system 850, such as an internal combustion engine, hybrid electric power plant, an all-electric engine, and/or another propulsion system type. The propulsion system 850 may be connected to a drive train of the vehicle 800, which may include a transmission, to enable the propulsion of the vehicle 800. The propulsion system 850 may be controlled in response to receiving signals from the throttle/accelerator 852. In some embodiments, one or more of the devices and/or components of the vehicle 800 can be the same as, or similar to, one or more of the devices discussed with respect to the example computing environment 100, PPE, and/or PE of FIG. 1. For example, the SoCs 804(A) and/or 804(B) can be the same as, or similar to, the functional blocks 110a, 110b of FIG. 1.

A steering system 854, which may include a steering wheel, may be used to steer the vehicle 800 (e.g., along a desired path or route) when the propulsion system 850 is operating (e.g., when the vehicle is in motion). The steering system 854 may receive signals from a steering actuator 856. The steering wheel may be optional for full automation (Level 5) functionality.

The brake sensor system 846 may be used to operate the vehicle brakes in response to receiving signals from the brake actuators 848 and/or brake sensors.

Controller(s) 836, which may include one or more system on chips (SoCs) 804 (FIG. 8C) and/or GPU(s), may provide signals (e.g., representative of commands) to one or more components and/or systems of the vehicle 800. For example, the controller(s) may send signals to operate the vehicle brakes via one or more brake actuators 848, to operate the steering system 854 via one or more steering actuators 856, to operate the propulsion system 850 via one or more throttle/accelerators 852. The controller(s) 836 may include one or more onboard (e.g., integrated) computing devices (e.g., supercomputers) that process sensor signals, and output operation commands (e.g., signals representing commands) to enable autonomous driving and/or to assist a human driver in driving the vehicle 800. The controller(s) 836 may include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 may handle two or more of the above functionalities, two or more controllers 836 may handle a single functionality, and/or any combination thereof.

The controller(s) 836 may provide the signals for controlling one or more components and/or systems of the vehicle 800 in response to sensor data received from one or more sensors (e.g., sensor inputs). The sensor data may be received from, for example and without limitation, global navigation satellite systems (“GNSS”) sensor(s) 858 (e.g., Global Positioning System sensor(s)), RADAR sensor(s) 860, ultrasonic sensor(s) 862, LiDAR sensor(s) 864, inertial measurement unit (IMU) sensor(s) 866 (e.g., accelerometer(s), gyroscope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) (e.g., as part of the brake sensor system 846), and/or other sensor types.

One or more of the controller(s) 836 may receive inputs (e.g., represented by input data) from an instrument cluster 832 of the vehicle 800 and provide outputs (e.g., represented by output data, display data, etc.) via a human-machine interface (HMI) display 834, an audible annunciator, a loudspeaker, and/or via other components of the vehicle 800. The outputs may include information such as vehicle velocity, speed, time, map data (e.g., the High Definition (“HD”) map 822 of FIG. 8C), location data (e.g., the vehicle's 800 location, such as on a map), direction, location of other vehicles (e.g., an occupancy grid), information about objects and status of objects as perceived by the controller(s) 836, etc. For example, the HMI display 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824 which may use one or more wireless antenna(s) 826 and/or modem(s) to communicate over one or more networks. For example, the network interface 824 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 826 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 8B is an example of camera locations and fields of view for the example autonomous vehicle 800 of FIG. 8A in accordance with some embodiments of the present disclosure. The cameras and respective fields of view are one example of an embodiment and are not intended to be limiting. For example, additional and/or alternative cameras may be included and/or the cameras may be located at different locations on the vehicle 800.

The camera types for the cameras may include, but are not limited to, digital cameras that may be adapted for use with the components and/or systems of the vehicle 800. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 870 that may be used to perceive objects coming into view from the periphery (e.g., pedestrians, crossing traffic or bicycles). Although only one wide-view camera is illustrated in FIG. 8B, there may be any number (including zero) of wide-view cameras 870 on the vehicle 800. In addition, any number of long-range camera(s) 898 (e.g., a long-view stereo camera pair) may be used for depth-based object detection, especially for objects for which a neural network has not yet been trained. The long-range camera(s) 898 may also be used for object detection and classification, as well as basic object tracking.

Any number of stereo cameras 868 may also be included in a front-facing configuration. In at least one embodiment, one or more of stereo camera(s) 868 may include an integrated control unit including a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 868 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868 may be used in addition to, or alternatively from, those described herein.

Cameras with a field of view that include portions of the environment to the side of the vehicle 800 (e.g., side-view cameras) may be used for surround view, providing information used to create and update the occupancy grid, as well as to generate side impact collision warnings. For example, surround camera(s) 874 (e.g., four surround cameras 874 as illustrated in FIG. 8B) may be positioned to on the vehicle 800. The surround camera(s) 874 may include wide-view camera(s) 870, fisheye camera(s), 360 degree camera(s), and/or the like. Four example, four fisheye cameras may be positioned on the vehicle's front, rear, and sides. In an alternative arrangement, the vehicle may use three surround camera(s) 874 (e.g., left, right, and rear), and may leverage one or more other camera(s) (e.g., a forward-facing camera) as a fourth surround view camera.

Cameras with a field of view that include portions of the environment to the rear of the vehicle 800 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 898, stereo camera(s) 868, infrared camera(s) 872, etc.), as described herein.

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 800 in FIG. 8C are illustrated as being connected via bus 802. The bus 802 may include a Controller Area Network (CAN) data interface (alternatively referred to herein as a “CAN bus”). A CAN may be a network inside the vehicle 800 used to aid in control of various features and functionality of the vehicle 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 802 is described herein as being a CAN bus, this is not intended to be limiting. For example, in addition to, or alternatively from, the CAN bus, FlexRay and/or Ethernet may be used. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the vehicle 800, and two or more busses 802 may communicate with the same components. In some examples, each SoC 804, each controller 836, and/or each computer within the vehicle may have access to the same input data (e.g., inputs from sensors of the vehicle 800), and may be connected to a common bus, such the CAN bus.

The vehicle 800 may include one or more controller(s) 836, such as those described herein with respect to FIG. 8A. The controller(s) 836 may be used for a variety of functions. The controller(s) 836 may be coupled to any of the various other components and systems of the vehicle 800, and may be used for control of the vehicle 800, artificial intelligence of the vehicle 800, infotainment for the vehicle 800, and/or the like.

The vehicle 800 may include a system(s) on a chip (SoC) 804. The SoC 804 may include CPU(s) 806, GPU(s) 808, processor(s) 810, cache(s) 812, accelerator(s) 814, data store(s) 816, and/or other components and features not illustrated. The SoC(s) 804 may be used to control the vehicle 800 in a variety of platforms and systems. For example, the SoC(s) 804 may be combined in a system (e.g., the system of the vehicle 800) with an HD map 822 which may obtain map refreshes and/or updates via a network interface 824 from one or more servers (e.g., server(s) 878 of FIG. 8D).

The CPU(s) 806 may include a CPU cluster or CPU complex (alternatively referred to herein as a “CCPLEX”). The CPU(s) 806 may include multiple cores and/or L2 caches. For example, in some embodiments, the CPU(s) 806 may include eight cores in a coherent multi-processor configuration. In some embodiments, the CPU(s) 806 may include four dual-core clusters where each cluster has a dedicated L2 cache (e.g., a 2 MB L2 cache). The CPU(s) 806 (e.g., the CCPLEX) may be configured to support simultaneous cluster operation enabling any combination of the clusters of the CPU(s) 806 to be active at any given time.

The CPU(s) 806 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 806 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 808 may include an integrated GPU (alternatively referred to herein as an “iGPU”). The GPU(s) 808 may be programmable and may be efficient for parallel workloads. The GPU(s) 808, in some examples, may use an enhanced tensor instruction set. The GPU(s) 408 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive and embedded use cases. For example, the GPU(s) 808 may be fabricated on a Fin field-effect transistor (FinFET). However, this is not intended to be limiting and the GPU(s) 808 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

In addition, the GPU(s) 808 may include an access counter that may keep track of the frequency of access of the GPU(s) 808 to memory of other processors. The access counter may help ensure that memory pages are moved to the physical memory of the processor that is accessing the pages most frequently.

The SoC(s) 804 may include any number of cache(s) 812, including those described herein. For example, the cache(s) 812 may include an L3 cache that is available to both the CPU(s) 806 and the GPU(s) 808 (e.g., that is connected both the CPU(s) 806 and the GPU(s) 808). The cache(s) 812 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 804 may include an arithmetic logic unit(s) (ALU(s)) which may be leveraged in performing processing with respect to any of the variety of tasks or operations of the vehicle 800—such as processing DNNs. In addition, the SoC(s) 804 may include a floating point unit(s) (FPU(s))—or other math coprocessor or numeric coprocessor types—for performing mathematical operations within the system. For example, the SoC(s) 804 may include one or more FPUs integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 814 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 808, and by using an inference accelerator, for example, a designer may target either the DLA(s) or the GPU(s) 808 for any function. For example, the designer may focus processing of CNNs and floating point operations on the DLA(s) and leave other functions to the GPU(s) 808 and/or other accelerator(s) 814.

The accelerator(s) 814 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 806. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 814 (e.g., the hardware acceleration cluster) may include a computer vision network on-chip and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 804 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 814 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LiDAR sensor(s) 864 or RADAR sensor(s) 860), among others.

The SoC(s) 804 may include data store(s) 816 (e.g., memory). The data store(s) 816 may be on-chip memory of the SoC(s) 804, which may store neural networks to be executed on the GPU and/or the DLA. In some examples, the data store(s) 816 may be large enough in capacity to store multiple instances of neural networks for redundancy and safety. The data store(s) 812 may include L2 or L3 cache(s) 812. Reference to the data store(s) 816 may include reference to the memory associated with the PVA, DLA, and/or other accelerator(s) 814, as described herein.

The SoC(s) 804 may include one or more processor(s) 810 (e.g., embedded processors). The processor(s) 810 may include a boot and power management processor that may be a dedicated processor and subsystem to handle boot power and management functions and related security enforcement. The boot and power management processor may be a part of the SoC(s) 804 boot sequence and may provide runtime power management services. The boot power and management processor may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, and/or accelerator(s) 814. If temperatures are determined to exceed a threshold, the boot and power management processor may enter a temperature fault routine and put the SoC(s) 804 into a lower power state and/or put the vehicle 800 into a chauffeur to safe stop mode (e.g., bring the vehicle 800 to a safe stop).

The processor(s) 810 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 810 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 810 may further include a real-time camera engine that may include a dedicated processor subsystem for handling real-time camera management.

The processor(s) 810 may further include a high-dynamic range signal processor that may include an image signal processor that is a hardware engine that is part of the camera processing pipeline.

The processor(s) 810 may include a video image compositor that may be a processing block (e.g., implemented on a microprocessor) that implements video post-processing functions needed by a video playback application to produce the final image for the player window. The video image compositor may perform lens distortion correction on wide-view camera(s) 870, surround camera(s) 874, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a mobile industry processor interface (MIPI) camera serial interface for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role.

The SoC(s) 804 may further include a broad range of peripheral interfaces to enable communication with peripherals, audio codecs, power management, and/or other devices. The SoC(s) 804 may be used to process data from cameras (e.g., connected over Gigabit Multimedia Serial Link and Ethernet), sensors (e.g., LiDAR sensor(s) 864, RADAR sensor(s) 860, etc. that may be connected over Ethernet), data from bus 802 (e.g., speed of vehicle 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks.

The SoC(s) 804 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 820) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 808.

In some examples, a CNN for facial recognition and vehicle owner identification may use data from camera sensors to identify the presence of an authorized driver and/or owner of the vehicle 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification may use data from microphones 896 to detect and identify emergency vehicle sirens. In contrast to conventional systems, that use general classifiers to detect sirens and manually extract features, the SoC(s) 804 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 436 and/or infotainment SoC 830, for example.

The vehicle 800 may include a GPU(s) 820 (e.g., discrete GPU(s), or dGPU(s)), that may be coupled to the SoC(s) 804 via a high-speed interconnect (e.g., NVIDIA's NVLINK). The GPU(s) 820 may provide additional artificial intelligence functionality, such as by executing redundant and/or different neural networks, and may be used to train and/or update neural networks based on input (e.g., sensor data) from sensors of the vehicle 800.

The vehicle 800 may further include the network interface 824 which may include one or more wireless antennas 826 (e.g., one or more wireless antennas for different communication protocols, such as a cellular antenna, a Bluetooth antenna, etc.). The network interface 824 may be used to enable wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 800 information about vehicles in proximity to the vehicle 800 (e.g., vehicles in front of, on the side of, and/or behind the vehicle 800). This functionality may be part of a cooperative adaptive cruise control functionality of the vehicle 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The vehicle 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The vehicle 800 may further include RADAR sensor(s) 860. The RADAR sensor(s) 860 may be used by the vehicle 800 for long-range vehicle detection, even in darkness and/or severe weather conditions. RADAR functional safety levels may be ASIL B. The RADAR sensor(s) 860 may use the CAN and/or the bus 802 (e.g., to transmit data generated by the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some example, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 800 surroundings at higher speeds with minimal interference from traffic in adjacent lanes. The other two antennae may expand the field of view, making it possible to quickly detect vehicles entering or leaving the vehicle's 800 lane.

Mid-range RADAR systems may include, as an example, a range of up to 460 m (front) or 80 m (rear), and a field of view of up to 42 degrees (front) or 450 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 800 may further include ultrasonic sensor(s) 862. The ultrasonic sensor(s) 862, which may be positioned at the front, back, and/or the sides of the vehicle 800, may be used for park assist and/or to create and update an occupancy grid. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B.

The vehicle 800 may include LiDAR sensor(s) 864. The LiDAR sensor(s) 864 may be used for object and pedestrian detection, emergency braking, collision avoidance, and/or other functions. The LiDAR sensor(s) 864 may be functional safety level ASIL B. In some examples, the vehicle 800 may include multiple LiDAR sensors 864 (e.g., two, four, six, etc.) that may use Ethernet (e.g., to provide data to a Gigabit Ethernet switch).

In some examples, the LiDAR sensor(s) 864 may be capable of providing a list of objects and their distances for a 360-degree field of view. Commercially available LiDAR sensor(s) 864 may have an advertised range of approximately 400 m, with an accuracy of 2-3 cm, and with support for a 400 Mbps Ethernet connection, for example. In some examples, one or more non-protruding LiDAR sensors 864 may be used. In such examples, the LiDAR sensor(s) 864 may be implemented as a small device that may be embedded into the front, rear, sides, and/or corners of the vehicle 800. The LiDAR sensor(s) 864, in such examples, may provide up to a 120-degree horizontal and 35-degree vertical field-of-view, with a 200 m range even for low-reflectivity objects. Front-mounted LiDAR sensor(s) 464 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 800. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 864 may be less susceptible to motion blur, vibration, and/or shock.

The vehicle may further include IMU sensor(s) 866. The IMU sensor(s) 866 may be located at a center of the rear axle of the vehicle 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include microphone(s) 896 placed in and/or around the vehicle 800. The microphone(s) 896 may be used for emergency vehicle detection and identification, among other things.

The vehicle may further include any number of camera types, including stereo camera(s) 468, wide-view camera(s) 870, infrared camera(s) 872, surround camera(s) 874, long-range and/or mid-range camera(s) 898, and/or other camera types. The cameras may be used to capture image data around an entire periphery of the vehicle 800. The types of cameras used depends on the embodiments and requirements for the vehicle 800, and any combination of camera types may be used to provide the necessary coverage around the vehicle 800. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 may further include vibration sensor(s) 842. The vibration sensor(s) 842 may measure vibrations of components of the vehicle, such as the axle(s). For example, changes in vibrations may indicate a change in road surfaces. In another example, when two or more vibration sensors 842 are used, the differences between the vibrations may be used to determine friction or slippage of the road surface (e.g., when the difference in vibration is between a power-driven axle and a freely rotating axle).

The vehicle 800 may include an ADAS system 838. The ADAS system 838 may include a SoC, in some examples. The ADAS system 838 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 860, LiDAR sensor(s) 864, and/or a camera(s). The ACC systems may include longitudinal ACC and/or lateral ACC. Longitudinal ACC monitors and controls the distance to the vehicle immediately ahead of the vehicle 800 and automatically adjusts the vehicle speed to maintain a safe distance from vehicles ahead. Lateral ACC performs distance keeping, and advises the vehicle 800 to change lanes when necessary. Lateral ACC is related to other ADAS applications such as LCA and CWS.

CACC uses information from other vehicles that may be received via the network interface 824 and/or the wireless antenna(s) 826 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 800), while the 12V communication concept provides information about traffic further ahead. CACC systems may include either or both 12V and V2V information sources. Given the information of the vehicles ahead of the vehicle 800, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 800 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 800 is backing up. Some RCTW systems include AEB to ensure that the vehicle brakes are applied to avoid a crash. RCTW systems may use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 may be a backup and/or secondary computer for providing perception information to a backup computer rationality module. The backup computer rationality monitor may run a redundant diverse software on hardware components to detect faults in perception and dynamic driving tasks. Outputs from the ADAS system 838 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may include and/or be included as a component of the SoC(s) 404.

In other examples, ADAS system 838 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 838 may be fed into the primary computer's perception block and/or the primary computer's dynamic driving task block. For example, if the ADAS system 838 indicates a forward crash warning due to an object immediately ahead, the perception block may use this information when identifying objects. In other examples, the secondary computer may have its own neural network which is trained and thus reduces the risk of false positives, as described herein.

The vehicle 800 may further include the infotainment SoC 830 (e.g., an in-vehicle infotainment system (IVI)). Although illustrated and described as a SoC, the infotainment system may not be a SoC, and may include two or more discrete components. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the vehicle 800. In some examples, the infotainment SoC 830 may be coupled to a supervisory MCU such that the GPU of the infotainment system may perform some self-driving functions in the event that the primary controller(s) 836 (e.g., the primary and/or backup computers of the vehicle 800) fail. In such an example, the infotainment SoC 830 may put the vehicle 800 into a chauffeur to safe stop mode, as described herein.

The vehicle 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 may include server(s) 878, network(s) 890, and vehicles, including the vehicle 800. The server(s) 878 may include a plurality of GPUs 884(A)-884(H) (collectively referred to herein as GPUs 884), PCIe switches 882(A)-882(D) (collectively referred to herein as PCIe switches 882), and/or CPUs 880(A)-880(B) (collectively referred to herein as CPUs 880). The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVSwitch SoC and the GPUs 884 and the PCIe switches 882 are connected via PCIe interconnects. Although eight GPUs 884, two CPUs 880, and four PCIe switches are illustrated, this is not intended to be limiting. Depending on the embodiment, each of the server(s) 878 may include any number of GPUs 884, CPUs 880, and/or PCIe switches 882. For example, the server(s) 878 may each include eight, sixteen, thirty-two, and/or more GPUs 484.

The server(s) 878 may receive, over the network(s) 890 and from the vehicles, image data representative of images showing unexpected or changed road conditions, such as recently commenced road-work. The server(s) 878 may transmit, over the network(s) 890 and to the vehicles, neural networks 892, updated neural networks 892, and/or map information 894, including information regarding traffic and road conditions. The updates to the map information 894 may include updates for the HD map 822, such as information regarding construction sites, potholes, detours, flooding, and/or other obstructions. In some examples, the neural networks 892, the updated neural networks 892, and/or the map information 894 may have resulted from new training and/or experiences represented in data received from any number of vehicles in the environment, and/or based on training performed at a datacenter (e.g., using the server(s) 878 and/or other servers).

The server(s) 878 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 890), and/or the machine learning models may be used by the server(s) 878 to remotely monitor the vehicles.

In some examples, the server(s) 878 may receive data from the vehicles and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the vehicle 800. For example, the deep-learning infrastructure may receive periodic updates from the vehicle 800, such as a sequence of images and/or objects that the vehicle 800 has located in that sequence of images (e.g., via computer vision and/or other machine learning object classification techniques). The deep-learning infrastructure may run its own neural network to identify the objects and compare them with the objects identified by the vehicle 800 and, if the results do not match and the infrastructure concludes that the Al in the vehicle 800 is malfunctioning, the server(s) 878 may transmit a signal to the vehicle 400 instructing a fail-safe computer of the vehicle 800 to assume control, notify the passengers, and complete a safe parking maneuver.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

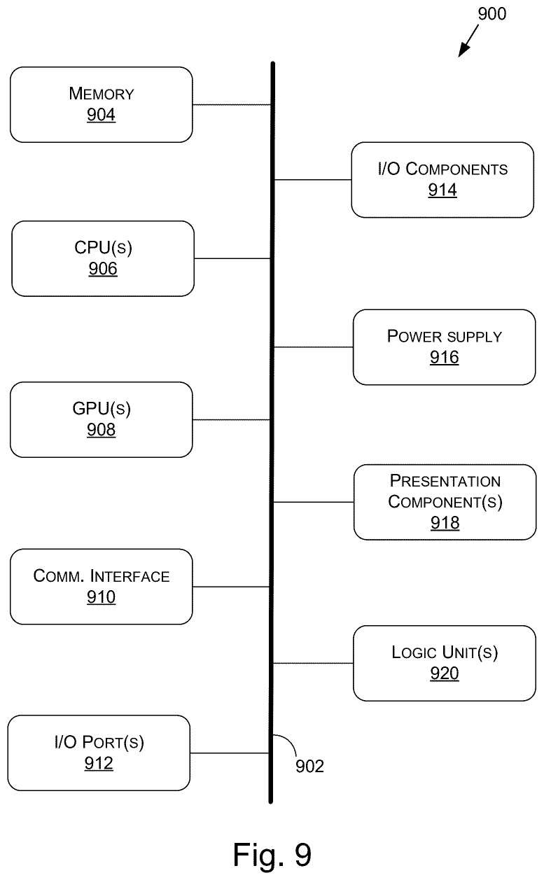

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may include one or more virtual machines (VMs), and/or any of the components thereof may include virtual components (e.g., virtual hardware components). For non-limiting examples, one or more of the GPUs 908 may include one or more vGPUs, one or more of the CPUs 906 may include one or more vCPUs, and/or one or more of the logic units 920 may include one or more virtual logic units. As such, a computing device(s) 900 may include discrete components (e.g., a full GPU dedicated to the computing device 900), virtual components (e.g., a portion of a GPU dedicated to the computing device 900), or a combination thereof. In some embodiments, the example computing device 900 and/or one or more components of the example computing device 900 can be the same as, or similar to, one or more of the device and/or components of FIG. 1 and FIG. 2.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900.

The computer-readable media may include both volatile and nonvolatile media, and removable and non-removable media. By way of example, and not limitation, the computer-readable media may include computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system). Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not include signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU). In some embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040. In some embodiments, one or more of the devices described with respect to FIG. 1 and FIG. 2 can interconnect with one or more devices of the example data center 1000 to establish communication connections. In these examples, the one or more of the devices described with respect to FIG. 1 and FIG. 2 can coordinate with the one or more devices of the data center 1000 to perform one or more of the operations described herein.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-1016(N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1033, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1033 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1033. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

In an aspect, the system can include the one or more processors in a control system for an autonomous or semi-autonomous machine. The system can include a perception system for an autonomous or semi-autonomous machine. The system can include a system implemented using a robot. The system can include an aerial system. The system can include a medical system. The system can include a boating system. The system can include a smart area monitoring system. The system can include a system for performing deep learning operations. The system can a system for performing simulation operations. The system can include a system for generating or presenting virtual reality (VR) content, augmented reality (AR) content, or mixed reality (MR) content. The system can include a system for performing digital twin operations. The system can include a system implemented using an edge device. The system can include a system incorporating one or more virtual machines (VMs). The system can include a system for generating synthetic data. The system can be implemented at least partially in a data center. The system can a system for performing conversational artificial intelligence (AI) operations. The system can include a system for performing generative AI operations. The system can include a system implementing language models. The system can include a system implementing vision language models (VLMs). The system can include a system implementing large language models (LLMs). The system can include a system implementing multi-modal language models. The system can include a system for hosting one or more real-time streaming applications. The system can include a system for performing light transport simulation. The system can include a system for performing collaborative content creation for 3D assets. In an aspect, the system can be implemented at least partially using cloud computing resources.

Having now described some illustrative implementations, the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any clam elements.

Scope of the systems and methods described herein is thus indicated by the appended claims, rather than the foregoing description. The scope of the claims includes equivalents to the meaning and scope of the appended claims.

What is claimed is:

1. A system, comprising:
one or more processors to:
obtain a plurality of encodings in parallel via respective lanes of a processor, each of the plurality of encodings corresponding to respective rows of a frame of data;
append, in parallel via the respective lanes of the processor, a first set of bits to each of a set of rows of the respective rows;
load, in parallel via the respective lanes of the processor, respective encodings of the plurality of encodings into corresponding rows of the set of rows;
append, in parallel via the respective lanes of the processor, a plurality of sets of bits to the set of rows;
shift one or more of the set of rows to align each of the encodings with at least one of the first set of bits or one or more of the plurality of sets of bits; and
load, in parallel via the respective lanes of the processor, each row of the set of rows including the encodings into a common row to form a frame encoding corresponding to the frame of the data.

2. The system of claim 1, wherein the one or more processors are to:
determine a length of the first set of bits based on a length of each of the plurality of encodings.

3. The system of claim 1, wherein the one or more processors are to:
determine differing lengths of each of the plurality of sets of bits, based on a width corresponding to the respective rows, a height of the frame of the data, and respective indices of each of the respective rows.

4. The system of claim 1, wherein the one or more processors are to:
initialize each of the plurality of encodings with a remainder having a value corresponding to zero.

5. The system of claim 1, wherein the one or more processors are to:
load the respective encodings of the plurality of encodings by a first XOR operation.

6. The system of claim 5, wherein the one or more processors are to:
load each of the encodings each of the set of rows into the common row by a second XOR operation subsequent to the first XOR operation.

7. The system of claim 1, wherein the one or more processors are to:
load, in parallel via the respective lanes of the processor, respective second encodings of the plurality of encodings into corresponding rows of the set of rows.

8. The system of claim 2, wherein the one or more processors are to:
generate the second encodings; and
generate the first encodings subsequent to generation of the second encodings.

9. The system of claim 1, wherein the plurality of encodings corresponds to error correction codes according to a cyclic redundancy check (CRC) format.

10. The system of claim 1, wherein the respective lanes each correspond to single-instruction multiple-data (SIMD) lanes of the processor.

11. The system of claim 1, wherein the one or more processors are comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system implementing vision language models (VLMs);
a system implementing large language models (LLMs);
a system implementing multi-modal language models;
a system for hosting one or more real-time streaming applications;
a system for performing light transport simulation;
a system for performing collaborative content creation for 3D assets; or
a system implemented at least partially using cloud computing resources.

12. A system-on-a-chip (SoC), comprising:
at least one graphics processing unit (GPU) providing multi-core parallel processing via a plurality of respective lanes, the GPU to:
determine, in parallel via a processor, a first set of bits for each row of a set of respective rows of a frame of data;
load, in parallel via the processor, respective encodings of the plurality of encodings into corresponding rows of the set of rows;
determine, in parallel via the processor, a plurality of sets of bits for the set of rows;
combine each of the encodings with at least one of the first set of bits or one or more of the plurality of sets of bits; and
load, in parallel via the processor, each of the set of rows including the encodings into a common row to form a frame encoding corresponding to the frame of the data.

13. The SoC of claim 1, comprising the one or more processors to:
determine a length of the first set of bits based on a length of each of the plurality of encodings.

14. A method, comprising:
obtaining a plurality of encodings in parallel via respective lanes of a processor, each of the plurality of encodings corresponding to respective rows of a frame of data;
appending, in parallel via the respective lanes of the processor, a first set of bits to each of a set of rows of the respective rows;
loading, in parallel via the respective lanes of the processor, respective encodings of the plurality of encodings into corresponding rows of the set of rows;
appending, in parallel via the respective lanes of the processor, a plurality of sets of bits to the set of rows;
shifting one or more of the set of rows to align each of the encodings with at least one of the first set of bits or one or more of the plurality of sets of bits; and
loading, in parallel via the respective lanes of the processor, each of the set of rows including the encodings into a common row to form a frame encoding corresponding to the frame of the data.

15. The method of claim 14, further comprising:
determining a length of the first set of bits based on a length of each of the plurality of encodings.

16. The method of claim 14, further comprising:
determining differing lengths of each of the plurality of sets of bits, based on a width corresponding to the respective rows, a height of the frame of the data, and respective indices of each of the respective rows.

17. The method of claim 14, further comprising:
initializing each of the plurality of encodings with a remainder having a value corresponding to zero.

18. The method of claim 14, further comprising:
loading the respective encodings of the plurality of encodings by a first XOR operation.

19. The method of claim 18, further comprising:
loading each of the encodings each of the set of rows into the common row by a second XOR operation subsequent to the first XOR operation.

20. The method of claim 14, further comprising:
loading, in parallel via the respective lanes of the processor, respective second encodings of the plurality of encodings into corresponding rows of the set of rows.
